(19) United States
(12) Patent Application Publication
(10) Pub. No.: US 2019/0037555 A1
(43) Pub. Date: Jan. 31, 2019

(54) METHOD FOR ALLOCATING RADIO RESOURCE IN WIRELESS COMMUNICATION SYSTEM AND DEVICE THEREFOR

(71) Applicant: LG ELECTRONICS INC., Seoul (KR)

(72) Inventors: Myoungseob KIM, Seoul (KR); Hanbyul SEO, Seoul (KR); Seungmin LEE, Seoul (KR)

(73) Assignee: LG ELECTRONICS INC., Seoul (KR)

(21) Appl. No.: 16/073,261

(22) PCT Filed: Jan. 19, 2017
(86) PCT No.: PCT/KR2017/000666

§ 371 Date: Jul. 26, 2018

Related U.S. Application Data
(60) Provisional application No. 62/287,449, filed on Jan. 27, 2016.
(60) Provisional application No. 62/313,154, filed on Mar. 25, 2016.

(51) Int. Cl. H04W 72/04; H04W 72/14; H04W 72/12

(52) U.S. Cl. CPC H04W 72/0413; H04W 72/042; H04W 4/40; H04W 72/1284; H04W 72/1268; H04W 72/14

(57) ABSTRACT

A method for allocating a radio resource in a wireless communication system and a device therefor are disclosed. Particularly, a method by which a radio resource is allocated to a terminal in a wireless communication system comprises the steps of: transmitting, to a base station, a first message for requesting the allocation of a semi-persistent signaling (SPS) resource for semi-persistently transmitting a specific uplink message, before receiving an uplink grant related to SPS from the base station; receiving a second message including information on an SPS resource allocated according to the SPS resource allocation request; and transmitting the specific uplink message to the base station by using an SPS resource identified using the received information, wherein the first message can include first information indicating a time point or period at which the specific uplink message is to be generated and/or second information indicating a time point at which the specific uplink message is to be transmitted.

### TECHNICAL FIELD

The present invention relates to a wireless communication system and, more particularly, to a method for allocating a semi-persistent scheduling resource and an apparatus supporting the same.

### BACKGROUND ART

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### DISCLOSURE

### Technical Problem

An eNB is unaware of the generation timing of uplink data transmitted by a UE in the situation in which transmission using semi-persistent scheduling (SPS) is performed. Accordingly, there is a problem in that the eNB cannot allocate an optimized SPS UL resource for the transmission of uplink data to the UE.

In order to solve the above problem, an object of the present invention proposes a method for a UE to be allocated with an optimized SPS UL radio resource from an eNB in a wireless communication system.

Furthermore, the present invention proposes a method for a UE to report information about the generation timing and/or generation period of uplink data to an eNB.

Furthermore, the present invention proposes a method for a UE to transmit a scheduling request (SR) to an eNB if SPS has been configured in the UE in order for the eNB to be implicitly aware of the generation timing of uplink data.

Furthermore, the present invention proposes a method for a UE to directly request a radio resource preferred (or required) to transmit uplink data from an eNB.

Furthermore, the present invention proposes a method for a UE to calculate an offset between the generation timing of uplink data and SPS resource allocation timing and to report information about the calculated offset to an eNB in order to be allocated with an optimized radio resource from the eNB.

Technical objects to be achieved by the present invention (or this specification) are not limited to the aforementioned technical objects, and other technical objects not described above may be evidently understood by a person having ordinary skill in the art to which the present invention pertains from the following description.

### Technical Solution

In a method of being allocated with a radio resource in a wireless communication system of an embodiment of the present invention, the method performed by a user equipment includes transmitting a first message to request the allocation of an semi-persistent signaling (SPS) resource for semi-persistently transmitting a specific uplink message to a base station before an uplink grant related to SPS is received from the base station, receiving a second message including information about the SPS resource allocated in response to the allocation request of the SPS resource, and transmitting the specific uplink message to the base station using an SPS resource identified using the received information. The first message may include at least one of first information indicating the timing or period in which the specific uplink message is generated and second information indicating the timing when the specific uplink message is transmitted.

Furthermore, preferably, the specific uplink message may include a message related to safety in a vehicle to everything (V2X) system.

Furthermore, preferably, the transmitting the first message may include transmitting a scheduling request to request the allocation of the SPS resource.

Furthermore, preferably, the information about the allocated SPS resource included in the second message may further include offset information related to subsequent SPS resource allocation.

Furthermore, preferably, if the first information is included in the first message, the second message is periodically received from the base station at the timing determined according to a specific equation.

Furthermore, preferably, the second information may include at least one of an upper value of a specific timing or an allocation timing of the SPS resource and a lower bound of the allocation timing of the SPS resource.

Furthermore, preferably, each of the upper value and the lower bound may be expressed as at least one of a system frame number and a subframe number.

Furthermore, preferably, the transmitting the first message to request the allocation of the SPS resource for semi-persistently transmitting the specific uplink message to a base station may include driving a timer set to monitor a message for the allocation of the SPS resource and transmitting the first message to the base station when the timer expires.

Furthermore, preferably, the method may further include receiving a third message including information about another SPS resource transmitted in at least one of a period and offset changed based on the allocation request of the SPS resource from the base station.

Furthermore, in a user equipment allocated with a radio resource in a wireless communication system of another embodiment of the present invention, the user equipment may include a transceiver for transmitting and receiving radio signals and a processor functionally coupled to the transceiver. In this case, the processor may control to transmit a first message to request the allocation of an semi-persistent signaling (SPS) resource for semi-persistently transmitting a specific uplink message to a base station before an uplink grant related to SPS is received from the base station, receive a second message including information about the SPS resource allocated in response to the allocation request of the SPS resource, and transmit the specific uplink message to the base station using an SPS resource identified using the received information. In this case, the first message may include at least one of first information indicating the timing or period in which the specific uplink message is generated and second information indicating the timing when the specific uplink message is transmitted.

### Advantageous Effects

According to an embodiment of the present invention, when a UE performs data transmission using semi-persistent scheduling, the interval between the generation timing of uplink data (UL data) and timing when UL data is actually transmitted can be reduced.

Accordingly, latency that may occur until uplink data is actually transmitted after the uplink data is generated can be effectively reduced.

Effects which may be obtained by the present invention are not limited to the aforementioned effects, and other technical effects not described above may be evidently understood by a person having ordinary skill in the art to which the present invention pertains from the following description.

### DESCRIPTION OF DRAWINGS

The accompany drawings, which are included to provide a further understanding of the present invention and are incorporated on and constitute a part of this specification illustrate embodiments of the present invention and together with the description serve to explain the principles of the present invention.

FIG. 1 illustrates the structure of a radio frame in a wireless communication system to which the present invention may be applied.

FIG. 2 is a diagram illustrating a resource grid for a downlink slot in a wireless communication system to which the present invention may be applied.

FIG. 3 illustrates a structure of downlink subframe in a wireless communication system to which the present invention may be applied.

FIG. 4 illustrates a structure of uplink subframe in a wireless communication system to which the present invention may be applied.

FIG. 5 illustrates an example of the shape in which PUCCH formats are mapped to the PUCCH region of uplink physical resource block in a wireless communication system to which the present invention may be applied.

FIG. 6 illustrates a structure of CQI channel in the case of normal CP in a wireless communication system to which the present invention may be applied.

FIG. 7 illustrates a structure of ACK/NACK channel in the case of normal CP in a wireless communication system to which the present invention may be applied.

FIG. 8 illustrates an example of transmission channel processing of UL-SCH in a wireless communication system to which the present invention may be applied.

FIG. 9 illustrates an example of signal processing process of uplink shared channel which is a transport channel in a wireless communication system to which the present invention may be applied.

FIG. 10 illustrates a reference signal pattern mapped to a downlink resource block pair in a wireless communication system to which the present invention may be applied.

FIG. 11 illustrates an uplink subframe including a sounding reference signal symbol in a wireless communication system to which the present invention may be applied.

FIG. 12 illustrates an example of component carrier and carrier aggregation in a wireless communication system to which the present invention may be applied.

FIG. 13 illustrates an example of subframe structure according to cross carrier scheduling in a wireless communication system to which the present invention may be applied.

FIG. 14 illustrates an example of generating and transmitting five SC-FDMA symbols during a slot in a wireless communication system to which the present invention may be applied.

FIG. 15 is a diagram illustrating a time-frequency resource block in the time frequency domain of a wireless communication system to which the present invention may be applied.

FIG. 16 is a diagram illustrating a resources allocation and retransmission process of an asynchronous HARQ method in a wireless communication system to which the present invention may be applied.

FIG. 17 is a diagram illustrating a carrier aggregation-based CoMP system in a wireless communication system to which the present invention may be applied.

FIG. 18 illustrates a relay node resource partition in a wireless communication system to which the present invention may be applied.

FIG. 19 is a diagram for illustrating the elements of a direct communication (D2D) scheme between UEs.

FIG. 20 is a diagram showing an embodiment of the configuration of a resource unit.

FIG. 21 shows a case where an SA resource pool and a following data channel resource pool periodically appear.

FIGS. 22 to 24 are diagrams showing examples of a relay process and resources for relay to which the present invention may be applied.

FIG. 25 shows a method of requesting SPS resource allocation according to an embodiment of the present invention.

FIG. 26 shows a method of requesting SPS resource allocation according to another embodiment of the present invention.

FIG. 27 shows a method of requesting SPS resource allocation according to yet another embodiment of the present invention.

FIG. 28 shows an operational flowchart of a UE that requests SPS resource allocation according to various embodiments of the present invention.

FIG. 29 illustrates a block diagram of a wireless communication apparatus according to an embodiment of the present invention.

### MODE FOR INVENTION

Hereinafter, preferred embodiments of the present invention will be described in detail with reference to the accompanying drawings. A detailed description to be disclosed below together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as global system for mobile communications (GSM)/general packet radio service (GPRS)/enhanced data rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

General System

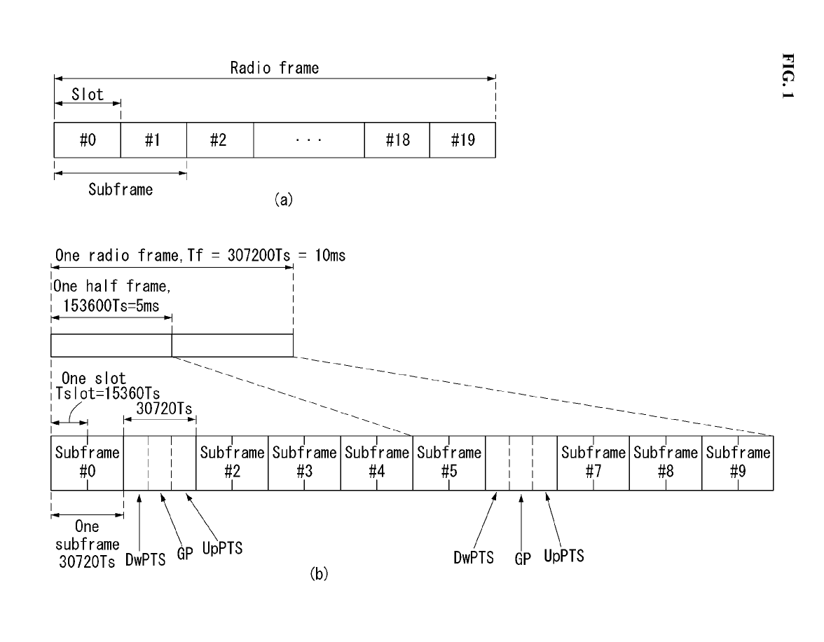

FIG. 1 illustrates a structure a radio frame in a wireless communication system to which the present invention can be applied.

In 3GPP LTE/LTE-A, radio frame structure type 1 may be applied to frequency division duplex (FDD) and radio frame structure type 2 may be applied to time division duplex (TDD) are supported.

In FIG. 1, the size of the radio frame in the time domain is represented by a multiple of a time unit of T_s=1/(15000*2048). The downlink and uplink transmissions are composed of radio frames having intervals of T_f=307200*T_s=10 ms.

FIG. 1(a) illustrates the type 1 radio frame structure. The type 1 radio frame may be applied to both full duplex FDD and half duplex FDD.

The radio frame includes 10 subframes. One radio frame includes 20 slots each having a length of T_slot=15360*T_s=0.5 ms. Indices 0 to 19 are assigned to the respective slots. One subframe includes two contiguous slots in the time domain, and a subframe i includes a slot 2i and a slot 2i+1. The time taken to send one subframe is called a transmission time interval (TTI). For example, the length of one subframe may be 1 ms, and the length of one slot may be 0.5 ms.

In FDD, uplink transmission and downlink transmission are classified in the frequency domain. There is no restriction to full duplex FDD, whereas a UE is unable to perform transmission and reception at the same time in a half duplex FDD operation.

One slot includes a plurality of orthogonal frequency division multiplexing (OFDM) symbols in the time domain and includes a plurality of resource blocks (RBs) in the frequency domain. An OFDM symbol is for expressing one symbol period because 3GPP LTE uses OFDMA in downlink. The OFDM symbol may also be called an SC-FDMA symbol or a symbol period. The resource block is a resource allocation unit and includes a plurality of contiguous subcarriers in one slot.

FIG. 1(b) shows the type 2 radio frame structure. The type 2 radio frame structure includes 2 half frames each having a length of 153600*T_s=5 ms. Each of the half frames includes 5 subframes each having a length of 30720*T_s=1 ms.

In the type 2 radio frame structure of a TDD system, an uplink-downlink configuration is a rule showing how uplink and downlink are allocated (or reserved) with respect to all of subframes. Table 1 shows the uplink-downlink configuration.

TABLE 1

| Uplink- | Downlink-to- | | | | | | | | | | |
|---|---|---|---|---|---|---|---|---|---|---|---|
| Downlink | Uplink Switch- | | | | | | | | | | |
| config- | point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 1, “D” indicates a subframe for downlink transmission, “U” indicates a subframe for uplink transmission, and “S” indicates a special subframe including the three fields of a downlink pilot time slot (DwPTS), a guard period (GP), and an uplink pilot time slot (UpPTS) for each of the subframes of the radio frame.

The DwPTS is used for initial cell search, synchronization or channel estimation by a UE. The UpPTS is used for an eNB to perform channel estimation and for a UE to perform uplink transmission synchronization. The GP is an interval for removing interference occurring in uplink due to the multi-path delay of a downlink signal between uplink and downlink.

Each subframe i includes the slot 2i and the slot 2i+1 each having “T_slot=15360*T_s=0.5 ms.”

The uplink-downlink configuration may be divided into seven types. The location and/or number of downlink subframes, special subframes, and uplink subframes are different in the seven types.

A point of time changed from downlink to uplink or a point of time changed from uplink to downlink is called a switching point. Switch-point periodicity means a cycle in which a form in which an uplink subframe and a downlink subframe switch is repeated in the same manner. The switch-point periodicity supports both 5 ms and 10 ms. In the case of a cycle of the 5 ms downlink-uplink switching point, the special subframe S is present in each half frame. In the case of the cycle of the 5 ms downlink-uplink switching point, the special subframe S is present only in the first half frame.

In all of the seven configurations, No. 0 and No. 5 subframes and DwPTSs are an interval for only downlink transmission. The UpPTSs, the subframes, and a subframe subsequent to the subframes are always an interval for uplink transmission.

Both an eNB and a UE may be aware of such uplink-downlink configurations as system information. The eNB may notify the UE of a change in the uplink-downlink allocation state of a radio frame by sending only the index of configuration information whenever uplink-downlink configuration information is changed. Furthermore, the configuration information is a kind of downlink control information. Like scheduling information, the configuration information may be transmitted through a physical downlink control channel (PDCCH) and may be transmitted to all of UEs within a cell in common through a broadcast channel as broadcast information.

Table 2 shows a configuration (i.e., the length of a DwPTS/GP/UpPTS) of the special subframe.

TABLE 2

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special | | cyclic | cyclic | | cyclic | cyclic |
| subframe | | prefix | prefix | | prefix | prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The structure of the radio frame according to the example of FIG. 1 is only one example. The number of subcarriers included in one radio frame, the number of slots included in one subframe, and the number of OFDM symbols included in one slot may be changed in various manners.

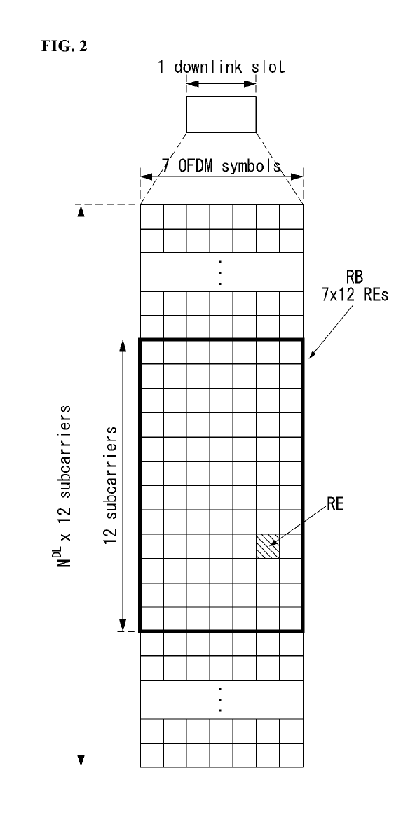

FIG. 2 is a diagram illustrating a resource grid for one downlink slot in the wireless communication system to which the present invention can be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element and one resource block includes 12×7 resource elements. The number of resource blocks included in the downlink slot, NDL is subordinated to a downlink transmission bandwidth.

A structure of the uplink slot may be the same as that of the downlink slot.

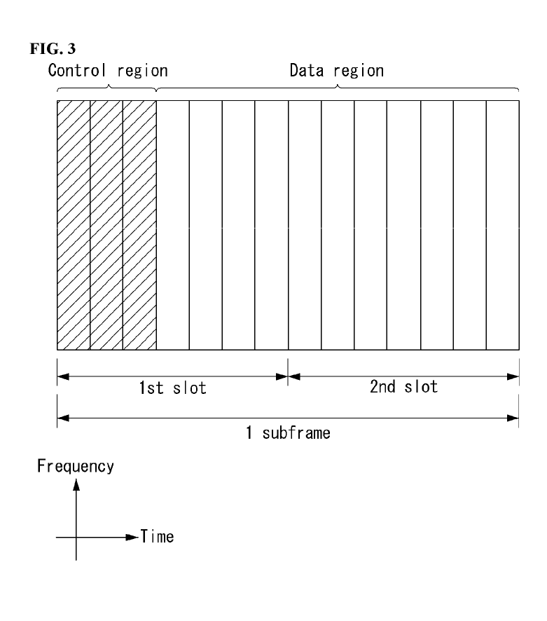

FIG. 3 illustrates a structure of a downlink subframe in the wireless communication system to which the present invention can be applied.

Referring to FIG. 3, a maximum of three former OFDM symbols in the first slot of the sub frame is a control region to which control channels are allocated and residual OFDM symbols is a data region to which a physical downlink shared channel (PDSCH) is allocated. Examples of the downlink control channel used in the 3GPP LTE include a Physical Control Format Indicator Channel (PCFICH), a Physical Downlink Control Channel (PDCCH), a Physical Hybrid-ARQ Indicator Channel (PHICH), and the like.

The PFCICH is transmitted in the first OFDM symbol of the subframe and transports information on the number (that is, the size of the control region) of OFDM symbols used for transmitting the control channels in the subframe. The PHICH which is a response channel to the uplink transports an Acknowledgement (ACK)/Not-Acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport A resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregate of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches the control information to a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

Enhanced PDCCH (EPDCCH) carries UE-specific signaling. The EPDCCH is located in a physical resource block (PRB) that is set to be terminal specific. In other words, as described above, the PDCCH can be transmitted in up to three OFDM symbols in the first slot in the subframe, but the EPDCCH can be transmitted in a resource region other than the PDCCH. The time (i.e., symbol) at which the EPDCCH in the subframe starts may be set in the UE through higher layer signaling (e.g., RRC signaling, etc.).

The EPDCCH is a transport format, a resource allocation and HARQ information associated with the DL-SCH and a transport format, a resource allocation and HARQ information associated with the UL-SCH, and resource allocation information associated with SL-SCH (Sidelink Shared Channel) and PSCCH Information, and so on. Multiple EPDCCHs may be supported and the terminal may monitor the set of EPCCHs.

The EPDCCH can be transmitted using one or more successive advanced CCEs (ECCEs), and the number of ECCEs per EPDCCH can be determined for each EPDCCH format.

Each ECCE may be composed of a plurality of enhanced resource element groups (EREGs). EREG is used to define the mapping of ECCE to RE. There are 16 EREGs per PRB pair. All REs are numbered from 0 to 15 in the order in which the frequency increases, except for the RE that carries the DMRS in each PRB pair.

The UE can monitor a plurality of EPDCCHs. For example, one or two EPDCCH sets may be set in one PRB pair in which the terminal monitors the EPDCCH transmission.

Different coding rates can be realized for the EPCCH by merging different numbers of ECCEs. The EPCCH may use localized transmission or distributed transmission, which may result in different mapping of the ECCE to the REs in the PRB.

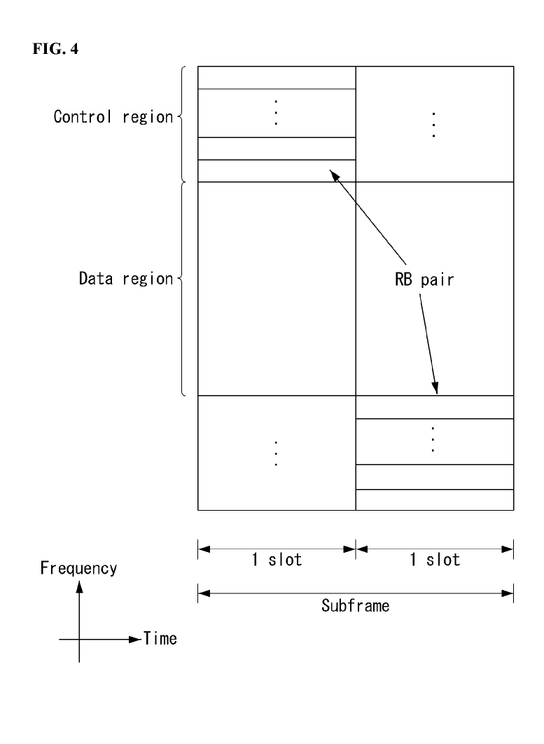

FIG. 4 illustrates a structure of an uplink subframe in the wireless communication system to which the present invention can be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe are allocated to the PUCCH for one terminal. RBs included in the RB pair occupy different subcarriers in two slots, respectively. The RB pair allocated to the PUCCH frequency-hops in a slot boundary.

Physical Uplink Control Channel (PUCCH)

Uplink control information (UCI) transmitted through a PUCCH may include the following scheduling request (SR), HARQ ACK/NACK information, and downlink channel measurement information.
Scheduling Request (SR): The SR is information used for requesting an uplink UL-SCH resource. The SR is transmitted using an On-off Keying (OOK) method.
HARQ ACK/NACK: The HARQ ACK/NACK is a response signal to a downlink data packet on a PDSCH. The HARQ ACK/NACK represents whether a downlink data packet is successfully received. ACK/NACK 1 bit is transmitted in response to a single downlink codeword, and ACK/NACK 2 bits are transmitted in response to two downlink codewords.
Channel State Information (CSI): The CSI is feedback information about a downlink channel. CSI may include at least one of a Channel Quality Indicator (CQI), a rank indicator (RI), a Precoding Matrix Indicator (PMI), and a Precoding Type Indicator (PTI). 20 bits are used per subframe.

The HARQ ACK/NACK information may be generated according to a downlink data packet on the PDSCH is successfully decoded. In the existing wireless communication system, 1 bit is transmitted as ACK/NACK information with respect to downlink single codeword transmission and 2 bits are transmitted as the ACK/NACK information with respect to downlink 2-codeword transmission.

The channel measurement information which designates feedback information associated with a multiple input multiple output (MIMO) technique may include a channel quality indicator (CQI), a precoding matrix index (PMI), and a rank indicator (RI). The channel measurement information may also be collectively expressed as the CQI.

bits may be used per subframe for transmitting the CQI.

The PUCCH may be modulated by using binary phase shift keying (BPSK) and quadrature phase shift keying (QPSK) techniques. Control information of a plurality of terminals may be transmitted through the PUCCH and when code division multiplexing (CDM) is performed to distinguish signals of the respective terminals, a constant amplitude zero autocorrelation (CAZAC) sequence having a length of 12 is primary used. Since the CAZAC sequence has a characteristic to maintain a predetermined amplitude in the time domain and the frequency domain, the CAZAC sequence has a property suitable for increasing coverage by decreasing a peak-to-average power ratio (PAPR) or cubic metric (CM) of the terminal. Further, the ACK/NACK information for downlink data transmission performed through the PUCCH is covered by using an orthogonal sequence or an orthogonal cover (OC).

Further, the control information transmitted on the PUCCH may be distinguished by using a cyclically shifted sequence having different cyclic shift (CS) values. The cyclically shifted sequence may be generated by cyclically shifting a base sequence by a specific cyclic shift (CS) amount. The specific CS amount is indicated by the cyclic shift (CS) index. The number of usable cyclic shifts may vary depending on delay spread of the channel. Various types of sequences may be used as the base sequence the CAZAC sequence is one example of the corresponding sequence.

Further, the amount of control information which the terminal may transmit in one subframe may be determined according to the number (that is, SC-FDMA symbols other an SC-FDMA symbol used for transmitting a reference signal (RS) for coherent detection of the PUCCH) of SC-FDMA symbols which are usable for transmitting the control information.

In the 3GPP LTE system, the PUCCH is defined as a total of 7 different formats according to the transmitted control information, a modulation technique, the amount of control information, and the like and an attribute of the uplink control information (UCI) transmitted according to each PUCCH format may be summarized as shown in Table 3 given below.

TABLE 3

| PUCCH Format | Uplink Control Information (UCI) |
|---|---|
| Format 1 | Scheduling Request(SR) (unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) for |
| | extended CP only |
| Format 2a | CQI and 1-bit HARQ ACK/NACK (20 + 1 coded bits) |
| Format 2b | CQI and 2-bit HARQ ACK/NACK (20 + 2 coded bits) |
| Format 3 | HARQ ACK/NACK, SR, CSI (48 coded bits) |

PUCCH format 1 is used for transmitting only the SR A waveform which is not modulated is adopted in the case of transmitting only the SR and this will be described below in detail.

PUCCH format 1a or 1b is used for transmitting the HARQ ACK/NACK. PUCCH format 1a or 1b may be used when only the HARQ ACK/NACK is transmitted in a predetermined subframe. Alternatively, the HARQ ACK/NACK and the SR may be transmitted in the same subframe by using PUCCH format 1a or 1b.

PUCCH format 2 is used for transmitting the CQI and PUCCH format 2a or 2b is used for transmitting the CQI and the HARQ ACK/NACK. In the case of an extended CP, PUCCH format 2 may be transmitted for transmitting the CQI and the HARQ ACK/NACK.

PUCCH format 3 is used for carrying encoded UCI of 48 bits. The PUCCH format 3 may carry HARQ ACK/NACK of a plurality of serving cells, SR (when existing), and CSI report of one serving cell.

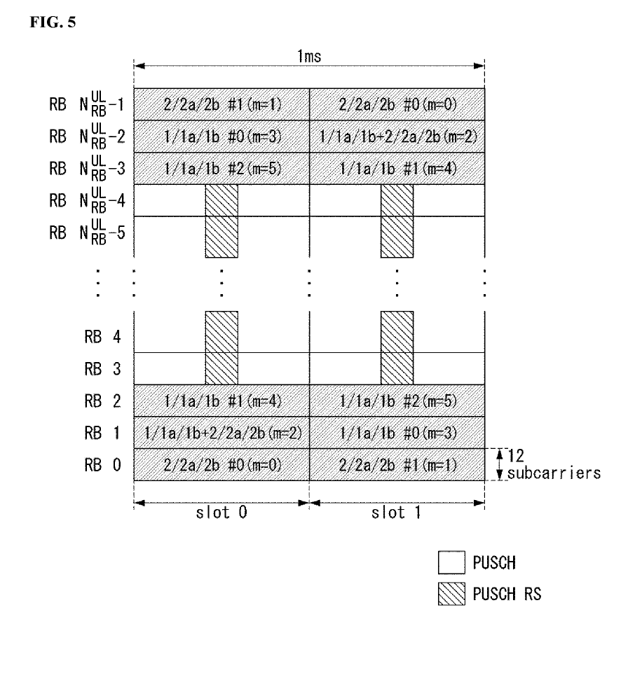

FIG. 5 illustrates one example of a type in which PUCCH formats are mapped to a PUCCH region of an uplink physical resource block in the wireless communication system to which the present invention can be applied.

In FIG. 5, N_{RB}^{UL} represents the number of resource blocks in the uplink and 0, 1, . . . , N_{RB}^{UL}−1 mean numbers of physical resource blocks. Basically, the PUCCH is mapped to both edges of an uplink frequency block. As illustrated in FIG. 5, PUCCH format 2/2a/2b is mapped to a PUCCH region expressed as m=0, 1 and this may be expressed in such a manner that PUCCH format 2/2a/2b is mapped to resource blocks positioned at a band edge. Further, both PUCCH format 2/2a/2b and PUCCH format 1/1a/1b may be mixed and mapped to a PUCCH region expressed as m=2. Next, PUCCH format 1/1a/1b may be mapped to a PUCCH region expressed as m=3, 4, and 5. The number (N_{RB}⁽²⁾) of PUCCH RBs which are usable by PUCCH format 2/2a/2b may be indicated to terminals in the cell by broadcasting signaling.

PUCCH format 2/2a/2b is described. PUCCH format 2/2a/2b is a control channel for transmitting channel measurement feedback (CQI, PMI, and RI).

A reporting period of the channel measurement feedbacks (hereinafter, collectively expressed as CQI information) and a frequency wise (alternatively, a frequency resolution) to be measured may be controlled by the base station. In the time domain, periodic and aperiodic CQI reporting may be supported. PUCCH format 2 may be used for only the periodic reporting and the PUSCH may be used for aperiodic reporting. In the case of the aperiodic reporting, the base station may instruct the terminal to transmit a scheduling resource loaded with individual CQI reporting for the uplink data transmission.

FIG. 6 illustrates a structure of a CQI channel in the case of a general CP in the wireless communication system to which the present invention can be applied.

In SC-FDMA symbols 0 to 6 of one slot, SC-FDMA symbols 1 and 5 (second and sixth symbols) may be used for transmitting a demodulation reference signal and the CQI information may be transmitted in the residual SC-FDMA symbols. Meanwhile, in the case of the extended CP, one SC-FDMA symbol (SC-FDMA symbol 3) is used for transmitting the DMRS.

In PUCCH format 2/2a/2b, modulation by the CAZAC sequence is supported and the CAZAC sequence having the length of 12 is multiplied by a QPSK-modulated symbol. The cyclic shift (CS) of the sequence is changed between the symbol and the slot. The orthogonal covering is used with respect to the DMRS.

The reference signal (DMRS) is loaded on two SC-FDMA symbols separated from each other by 3 SC-FDMA symbols among 7 SC-FDMA symbols included in one slot and the CQI information is loaded on 5 residual SC-FDMA symbols. Two RSs are used in one slot in order to support a high-speed terminal. Further, the respective terminals are distinguished by using the CS sequence. CQI information symbols are modulated and transferred to all SC-FDMA symbols and the SC-FDMA symbol is constituted by one sequence. That is, the terminal modulates and transmits the CQI to each sequence.

The number of symbols which may be transmitted to one TTI is 10 and modulation of the CQI information is determined up to QPSK. When QPSK mapping is used for the SC-FDMA symbol, since a CQI value of 2 bits may be loaded, a CQI value of 10 bits may be loaded on one slot. Therefore, a CQI value of a maximum of 20 bits may be loaded on one subframe. A frequency domain spread code is used for spreading the CQI information in the frequency domain.

The CAZAC sequence (for example, ZC sequence) having the length of 12 may be used as the frequency domain spread code. CAZAC sequences having different CS values may be applied to the respective control channels to be distinguished from each other. IFFT is performed with respect to the CQI information in which the frequency domain is spread.

12 different terminals may be orthogonally multiplexed on the same PUCCH RB by a cyclic shift having 12 equivalent intervals. In the case of a general CP, a DMRS sequence on SC-FDMA symbol 1 and 5 (on SC-FDMA symbol 3 in the case of the extended CP) is similar to a CQI signal sequence on the frequency domain, but the modulation of the CQI information is not adopted.

The terminal may be semi-statically configured by upper-layer signaling so as to periodically report different CQI, PMI, and RI types on PUCCH resources indicated as PUCCH resource indexes (n_{PUCCH}^{(1,\tilde{p})}n_{PUCCH}^{(2,\tilde{p})}, and n_{PUCCH}^{(3,\tilde{p})}). Herein, the PUCCH resource index (n_{PUCCH}^{(2,\tilde{p})}) is information indicating the PUCCH region used for PUCCH format 2/2a/2b and a CS value to be used.

Hereinafter, PUCCH formats 1a and 1b will be described.

In the PUCCH format 1a/1b, a symbol modulated using a BPSK or QPSK modulation method is multiplied with a CAZAC sequence of a length 12. For example, a result in which a CAZAC sequence r (n) (n=0, 1, 2, . . . , N−1) of a length N is multiplied to a modulation symbol d(0) becomes y(0), y(1), y(2), . . . , y(N−1). y(0), y(1), y(2), . . . , y(N−1) symbols may be referred to as a block of symbol. After a CAZAC sequence is multiplied to a modulation symbol, block-wise diffusion using an orthogonal sequence is applied.

A Hadamard sequence of a length 4 is used for general ACK/NACK information, and a Discrete Fourier Transform (DFT) sequence of a length 3 is used for shortened ACK/NACK information and a reference signal.

A Hadamard sequence of a length 2 is used for a reference signal of an extended CP.

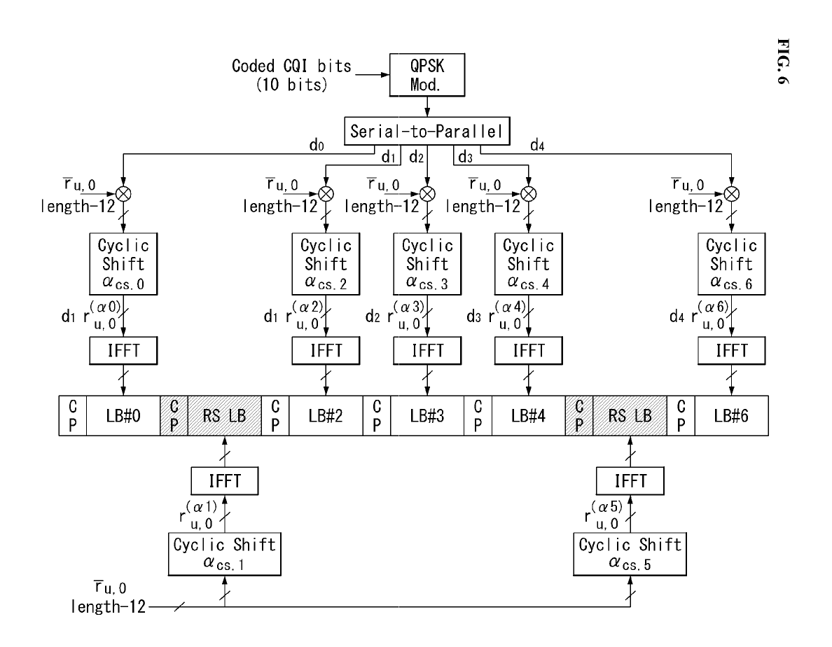

FIG. 7 illustrates a structure of an ACK/NACK channel in the case of a general CP in the wireless communication system to which the present invention can be applied.

In FIG. 7, a PUCCH channel structure for transmitting the HARQ ACK/NACK without the CQI is exemplarily illustrated.

The reference signal (DMRS) is loaded on three consecutive SC-FDMA symbols in a middle part among 7 SC-FDMA symbols and the ACK/NACK signal is loaded on 4 residual SC-FDMA symbols.

Meanwhile, in the case of the extended CP, the RS may be loaded on two consecutive symbols in the middle part. The number of and the positions of symbols used in the RS may vary depending on the control channel and the numbers and the positions of symbols used in the ACK/NACK signal associated with the positions of symbols used in the RS may also correspondingly vary depending on the control channel.

Acknowledgment response information (not scrambled status) of 1 bit and 2 bits may be expressed as one HARQ ACK/NACK modulated symbol by using the BPSK and QPSK modulation techniques, respectively. A positive acknowledgement response (ACK) may be encoded as ‘1’ and a negative acknowledgment response (NACK) may be encoded as ‘0’.

When a control signal is transmitted in an allocated band, 2-dimensional (D) spread is adopted in order to increase a multiplexing capacity. That is, frequency domain spread and time domain spread are simultaneously adopted in order to increase the number of terminals or control channels which may be multiplexed.

A frequency domain sequence is used as the base sequence in order to spread the ACK/NACK signal in the frequency domain. A Zadoff-Chu (ZC) sequence which is one of the CAZAC sequences may be used as the frequency domain sequence. For example, different CSs are applied to the ZC sequence which is the base sequence, and as a result, multiplexing different terminals or different control channels may be applied. The number of CS resources supported in an SC-FDMA symbol for PUCCH RBs for HARQ ACK/NACK transmission is set by a cell-specific upper-layer signaling parameter (Δ_{shift}^{PUCCH}).

The ACK/NACK signal which is frequency-domain spread is spread in the time domain by using an orthogonal spreading code. As the orthogonal spreading code, a Walsh-Hadamard sequence or DFT sequence may be used. For example, the ACK/NACK signal may be spread by using an orthogonal sequence (w0, w1, w2, and w3) having the length of 4 with respect to 4 symbols. Further, the RS is also spread through an orthogonal sequence having the length of 3 or 2. This is referred to as orthogonal covering (OC).

Multiple terminals may be multiplexed by a code division multiplexing (CDM) scheme by using the CS resources in the frequency domain and the OC resources in the time domain described above. That is, ACK/NACK information and RSs of a lot of terminals may be multiplexed on the same PUCCH RB.

In respect to the time-domain spread CDM, the number of spreading codes supported with respect to the ACK/NACK information is limited by the number of RS symbols. That is, since the number of RS transmitting SC-FDMA symbols is smaller than that of ACK/NACK information transmitting SC-FDMA symbols, the multiplexing capacity of the RS is smaller than that of the ACK/NACK information.

For example, in the case of the general CP, the ACK/NACK information may be transmitted in four symbols and not 4 but 3 orthogonal spreading codes are used for the ACK/NACK information and the reason is that the number of RS transmitting symbols is limited to 3 to use only 3 orthogonal spreading codes for the RS.

In the case of the subframe of the general CP, when 3 symbols are used for transmitting the RS and 4 symbols are used for transmitting the ACK/NACK information in one slot, for example, if 6 CSs in the frequency domain and 3 orthogonal cover (OC) resources may be used, HARQ acknowledgement responses from a total of 18 different terminals may be multiplexed in one PUCCH RB. In the case of the subframe of the extended CP, when 2 symbols are used for transmitting the RS and 4 symbols are used for transmitting the ACK/NACK information in one slot, for example, if 6 CSs in the frequency domain and 2 orthogonal cover (OC) resources may be used, the HARQ acknowledgement responses from a total of 12 different terminals may be multiplexed in one PUCCH RB.

Next, PUCCH format 1 is described. The scheduling request (SR) is transmitted by a scheme in which the terminal requests scheduling or does not request the scheduling. An SR channel reuses an ACK/NACK channel structure in PUCCH format 1a/1b and is configured by an on-off keying (OOK) scheme based on an ACK/NACK channel design. In the SR channel, the reference signal is not transmitted. Therefore, in the case of the general CP, a sequence having a length of 7 is used and in the case of the extended CP, a sequence having a length of 6 is used. Different cyclic shifts (CSs) or orthogonal covers (OCs) may be allocated to the SR and the ACK/NACK. That is, the terminal transmits the HARQ ACK/NACK through a resource allocated for the SR in order to transmit a positive SR. The terminal transmits the HARQ ACK/NACK through a resource allocated for the ACK/NACK in order to transmit a negative SR

Next, an enhanced-PUCCH (e-PUCCH) format is described. An e-PUCCH may correspond to PUCCH format 3 of an LTE-A system. A block spreading technique may be applied to ACK/NACK transmission using PUCCH format 3.

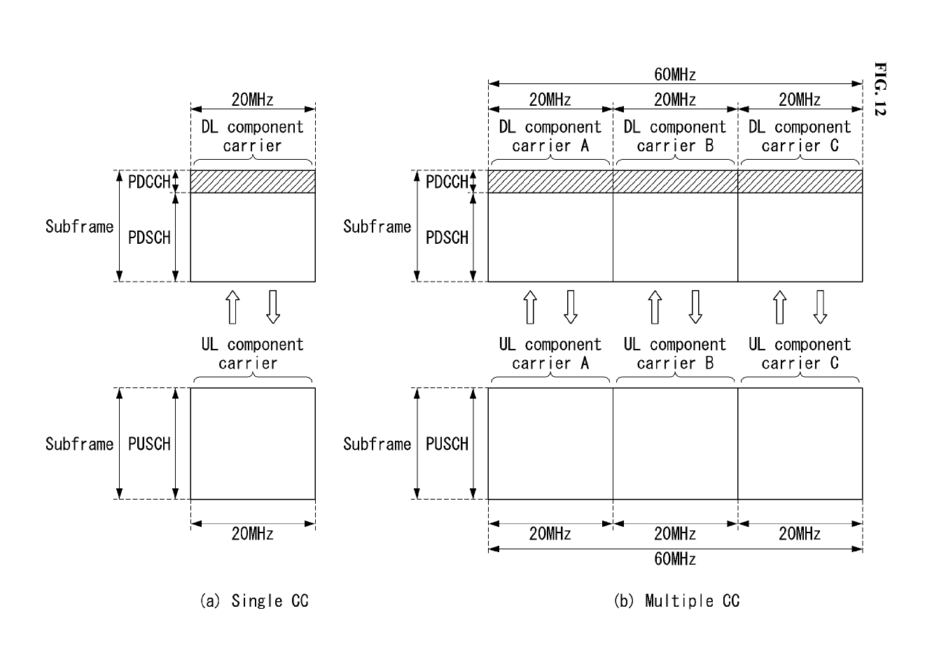

The block spread scheme is described in detail later with reference to FIG. 14.

PUCCH Piggybacking

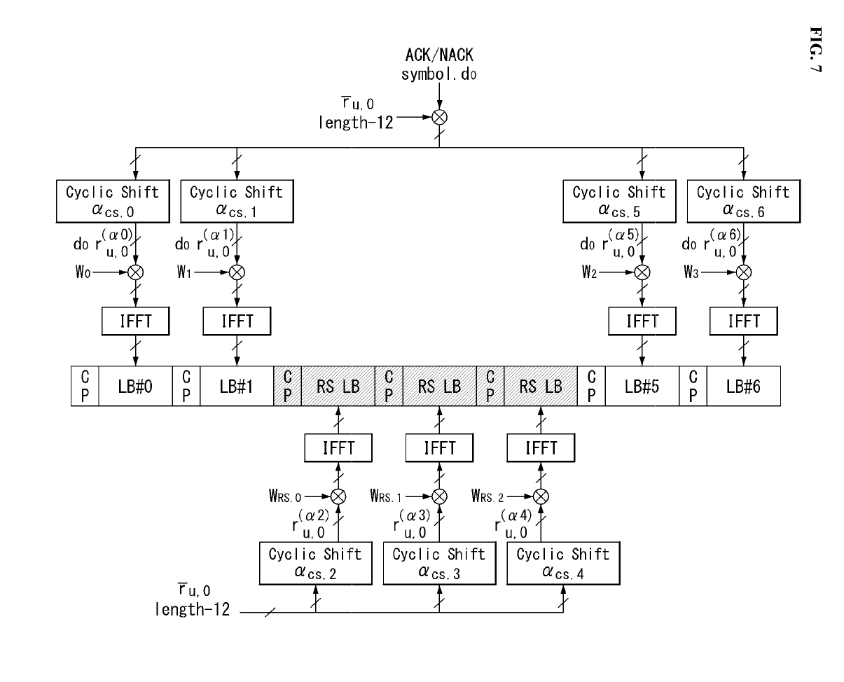

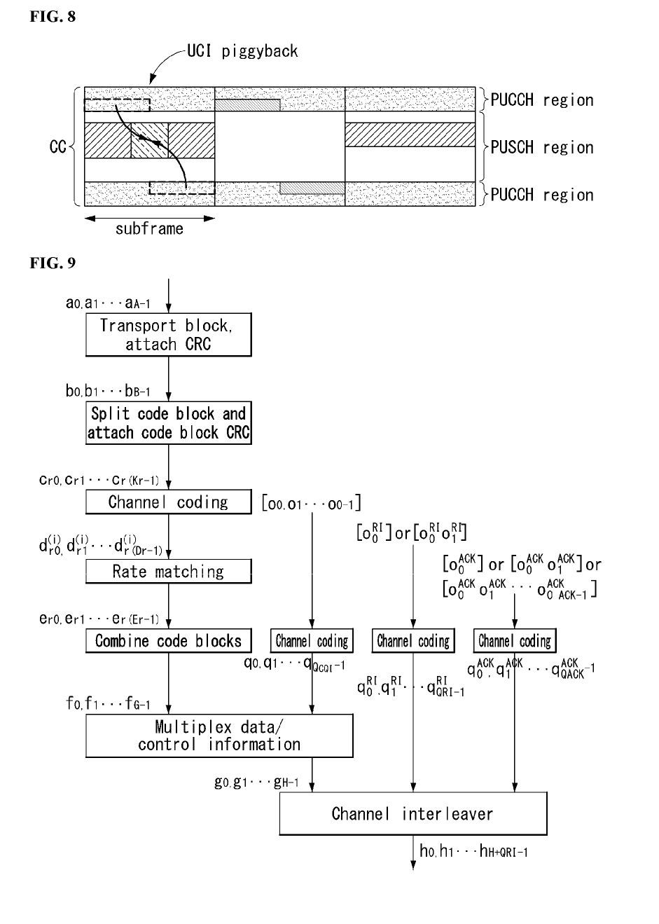

FIG. 8 illustrates one example of transport channel processing of a UL-SCH in the wireless communication system to which the present invention can be applied.

In a 3GPP LTE system (=E-UTRA, Rel. 8), in the case of the UL, single carrier transmission having an excellent peak-to-average power ratio (PAPR) or cubic metric (CM) characteristic which influences the performance of a power amplifier is maintained for efficient utilization of the power amplifier of the terminal. That is, in the case of transmitting the PUSCH of the existing LTE system, data to be transmitted may maintain the single carrier characteristic through DFT-precoding and in the case of transmitting the PUCCH, information is transmitted while being loaded on a sequence having the single carrier characteristic to maintain the single carrier characteristic. However, when the data to be DFT-precoded is non-contiguously allocated to a frequency axis or the PUSCH and the PUCCH are simultaneously transmitted, the single carrier characteristic deteriorates. Therefore, when the PUSCH is transmitted in the same subframe as the transmission of the PUCCH as illustrated in FIG. 11, uplink control information (UCI) to be transmitted to the PUCCH is transmitted (piggyback) together with data through the PUSCH.

Since the PUCCH and the PUSCH may not be simultaneously transmitted as described above, the existing LTE terminal uses a method that multiplexes uplink control information (UCI) (CQI/PMI, HARQ-ACK, RI, and the like) to the PUSCH region in a subframe in which the PUSCH is transmitted.

As one example, when the channel quality indicator (CQI) and/or precoding matrix indicator (PMI) needs to be transmitted in a subframe allocated to transmit the PUSCH, UL-SCH data and the CQI/PMI are multiplexed after DFT-spreading to transmit both control information and data. In this case, the UL-SCH data is rate-matched by considering a CQI/PMI resource. Further, a scheme is used, in which the control information such as the HARQ ACK, the RI, and the like punctures the UL-SCH data to be multiplexed to the PUSCH region.

FIG. 9 illustrates one example of a signal processing process of an uplink share channel of a transport channel in the wireless communication system to which the present invention can be applied.

Herein, the signal processing process of the uplink share channel (hereinafter, referred to as “UL-SCH”) may be applied to one or more transport channels or control information types.

Referring to FIG. 9, the UL-SCH transfers data to a coding unit in the form of a transport block (TB) once every a transmission time interval (TTI).

A CRC parity bit p₀, p₁, p₂, p₃, . . . , p_{L-1} is attached to a bit of the transport block received from the upper layer (S90). In this case, A represents the size of the transport block and L represents the number of parity bits. Input bits to which the CRC is attached are shown in b₀, b₁, b₂, b₃, . . . , b_{B-1}. In this case, B represents the number of bits of the transport block including the CRC.

b₀, b₁, b₂, b₃ . . . , b_{B-1} is segmented into multiple code blocks (CBs) according to the size of the TB and the CRC is attached to multiple segmented CBs (S91). Bits after the code block segmentation and the CRC attachment are shown in cᵣ₀, cᵣ₁, cᵣ₂, cᵣ₃, . . . , c_{r(K}_{ᵣ}₋₁₎. Herein, r represents No. (r=0, . . . , C−1) of the code block and Kr represents the bit number depending on the code block r. Further, C represents the total number of code blocks.

Subsequently, channel coding is performed (S92). Output bits after the channel coding are shown in dᵣ₀⁽ⁱ⁾, dᵣ₁⁽ⁱ⁾, dᵣ₂⁽ⁱ⁾, dᵣ₃⁽ⁱ⁾, . . . , d_{r(D}_{ᵣ}₋₁₎⁽ⁱ⁾. In this case, i represents an encoded stream index and may have a value of 0, 1, or 2. Dr represents the number of bits of the i-th encoded stream for the code block r. r represents the code block number (r=0, . . . , C−1) and C represents the total number of code blocks. Each code block may be encoded by turbo coding.

Subsequently, rate matching is performed (S93). Bits after the rate matching are shown in eᵣ₀, eᵣ₁, eᵣ₂, eᵣ₃, . . . , e_{r(E}_{ᵣ}₋₁₎. In this case, r represents the code block number (r=0, . . . , C−1) and C represents the total number of code blocks. Er represents the number of rate-matched bits of the r-th code block.

Subsequently, concatenation among the code blocks is performed again (S94). Bits after the concatenation of the code blocks is performed are shown in f₀, f₁, f₂, f₃, . . . , f_{G-1}. In this case, G represents the total number of bits encoded for transmission and when the control information is multiplexed with the UL-SCH, the number of bits used for transmitting the control information is not included.

Meanwhile, when the control information is transmitted in the PUSCH, channel coding of the CQI/PMI, the RI, and the ACK/NACK which are the control information is independently performed (S96, S97, and S98). Since different encoded symbols are allocated for transmitting each piece of control information, the respective control information has different coding rates.

In time division duplex (TDD), as an ACK/NACK feedback mode, two modes of ACK/NACK bundling and ACK/NACK multiplexing are supported by an upper-layer configuration. ACK/NACK information bits for the ACK/NACK bundling are constituted by 1 bit or 2 bits and ACK/NACK information bits for the ACK/NACK multiplexing are constituted by 1 to 4 bits.

After the concatenation among the code blocks in step S94, encoded bits f₀, f₁, f₂, f₃ . . . , f_{G-1} of the UL-SCH data and encoded bits q₀, q₁, q₂, q₃ . . . N_{N}_{_{L}}_{-Q}_{_{CQI}}₋₁ of the CQI/PMI are multiplexed (S95). A multiplexed result of the data and the CQI/PMI is shown in g̅₀,g̅₁,g̅₂,g̅₃, . . . , g̅_{H′-1} In this case, g̅ᵢ (i=0, . . . H′−1) represents a column vector having a length of (Qₘ·N_{L}). H=(G+N_{L}·Q_{CQI}) and H′=H/(N_{L}·Qₘ). N_{L} represents the number of layers mapped to a UL-SCH transport block and H represents the total number of encoded bits allocated to N_{L} transport layers mapped with the transport block for the UL-SCH data and the CQI/PMI information.

Subsequently, the multiplexed data and CQI/PMI, a channel encoded RI, and the ACK/NACK are channel-interleaved to generate an output signal (S99).

Reference Signal(RS)

In the wireless communication system, since the data is transmitted through the radio channel, the signal may be distorted during transmission. In order for the receiver side to accurately receive the distorted signal, the distortion of the received signal needs to be corrected by using channel information. In order to detect the channel information, a signal transmitting method know by both the transmitter side and the receiver side and a method for detecting the channel information by using an distortion degree when the signal is transmitted through the channel are primarily used. The aforementioned signal is referred to as a pilot signal or a reference signal (RS).

Recently, when packets are transmitted in most of mobile communication systems, multiple transmitting antennas and multiple receiving antennas are adopted to increase transmission/reception efficiency rather than a single transmitting antenna and a single receiving antenna. When the data is transmitted and received by using the MIMO antenna, a channel state between the transmitting antenna and the receiving antenna need to be detected in order to accurately receive the signal. Therefore, the respective transmitting antennas need to have individual reference signals.

Reference signal in a wireless communication system can be mainly categorized into two types. In particular, there are a reference signal for the purpose of channel information acquisition and a reference signal used for data demodulation. Since the object of the former reference signal is to enable user equipment (UE) to acquire a channel information in downlink (DL), the former reference signal should be transmitted on broadband. And, even if the UE does not receive DL data in a specific subframe, it should perform a channel measurement by receiving the corresponding reference signal. Moreover, the corresponding reference signal can be used for a measurement for mobility management of a handover or the like. The latter reference signal is the reference signal transmitted together when an eNB transmits DL data. If UE receives the corresponding reference signal, the UE can perform channel estimation, thereby demodulating data. And, the corresponding reference signal should be transmitted in a data transmitted region.

5 types of downlink reference signals are defined.
A cell-specific reference signal (CRS)
A multicast-broadcast single-frequency network reference signal (MBSFN RS)
A UE-specific reference signal or a demodulation reference signal (DM-RS)
A positioning reference signal (PRS)
A channel state information reference signal (CSI-RS)

One RS is transmitted in each downlink antenna port.

The CRS is transmitted in all of downlink subframe in a cell supporting PDSCH transmission. The CRS is transmitted in one or more of antenna ports 0-3. The CRS is transmitted only in Δf=15 kHz.

The MBSFN RS is transmitted in the MBSFN region of an MBSFN subframe only when a physical multicast channel (PMCH) is transmitted. The MBSFN RS is transmitted in an antenna port 4. The MBSFN RS is defined only in an extended CP.

The DM-RS is supported for the transmission of a PDSCH and is transmitted in antenna ports p=5, p=7, p=8 or p=7, 8, . . . , v+6. In this case,

u is the number of layers which is used for PDSCH transmission. The DM-RS is present and valid for the demodulation of a PDSCH only when PDSCH transmission is associated in a corresponding antenna port. The DM-RS is transmitted only in a resource block (RB) to which a corresponding PDSCH is mapped.

If any one of physical channels or physical signals other than the DM-RS is transmitted using the resource element (RE) of the same index pair (k,l) as that of a RE in which a DM-RS is transmitted regardless of an antenna port “p”, the DM-RS is not transmitted in the RE of the corresponding index pair (k,l).

The PRS is transmitted only in a resource block within a downlink subframe configured for PRS transmission.

If both a common subframe and an MBSFN subframe are configured as positioning subframes within one cell, OFDM symbols within the MBSFN subframe configured for PRS transmission use the same CP as that of a subframe #0. If only an MBSFN subframe is configured as a positioning subframe within one cell, OFDM symbols configured for a PRS within the MBSFN region of the corresponding subframe use an extended CP.

The start point of an OFDM symbol configured for PRS transmission within a subframe configured for the PRS transmission is the same as the start point of a subframe in which all of OFDM symbols have the same CP length as an OFDM symbol configured for the PRS transmission.

The PRS is transmitted in an antenna port 6.

The PRS is not mapped to RE (k,l) allocated to a physical broadcast channel (PBCH), a PSS or and SSS regardless of an antenna port “p.”

The PRS is defined only in Δf=15 kHz.

The CSI-RS is transmitted in 1, 2, 4 or 8 antenna ports using p=15, p=15, 16, p=15, . . . , 18 and p=15, . . . , 22, respectively.

The CSI-RS is defined only in Δf=15 kHz.

A reference signal is described in more detail.

The CRS is a reference signal for obtaining information about the state of a channel shared by all of UEs within a cell and measurement for handover, etc. The DM-RS is used to demodulate data for only specific UE. Information for demodulation and channel measurement may be provided using such reference signals. That is, the DM-RS is used for only data demodulation, and the CRS is used for the two purposes of channel information acquisition and data demodulation.

The receiver side (i.e., terminal) measures the channel state from the CRS and feeds back the indicators associated with the channel quality, such as the channel quality indicator (CQI), the precoding matrix index (PMI), and/or the rank indicator (RI) to the transmitting side (i.e., an eNB). The CRS is also referred to as a cell-specific RS. On the contrary, a reference signal associated with a feed-back of channel state information (CSI) may be defined as CSI-RS.

The DM-RS may be transmitted through resource elements when data demodulation on the PDSCH is required. The terminal may receive whether the DM-RS is present through the upper layer and is valid only when the corresponding PDSCH is mapped. The DM-RS may be referred to as the UE-specific RS or the demodulation RS (DMRS).

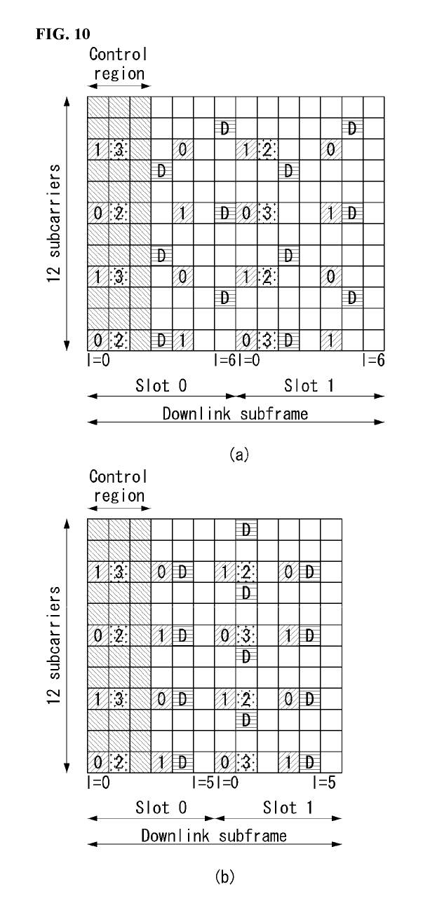

FIG. 10 illustrates a reference signal pattern mapped to a downlink resource block pair in the wireless communication system to which an embodiment of the present invention may be applied.

Referring to FIG. 10, as a unit in which the reference signal is mapped, the downlink resource block pair may be expressed by one subframe in the time domain x 12 subcarriers in the frequency domain. That is, one resource block pair has a length of 14 OFDM symbols in the case of a normal cyclic prefix (CP) (FIG. 14(a)) and a length of 12 OFDM symbols in the case of an extended cyclic prefix (CP) (FIG. 14(b)). Resource elements (REs) represented as ‘0’, ‘1’, ‘2’, and ‘3’ in a resource block lattice mean the positions of the CRSs of antenna port indexes ‘0’, ‘1’, ‘2’, and ‘3’, respectively and resource elements represented as ‘D’ means the position of the DM-RS.

Hereinafter, when the CRS is described in more detail, the CRS is used to estimate a channel of a physical antenna and distributed in a whole frequency band as the reference signal which may be commonly received by all terminals positioned in the cell. That is, the CRS is transmitted in each subframe across a broadband as a cell-specific signal. Further, the CRS may be used for the channel quality information (CSI) and data demodulation.

The CRS is defined as various formats according to an antenna array at the transmitter side (base station). The 3GPP LTE system (for example, release-8) supports various antenna arrays and a downlink signal transmitting side has three types of antenna arrays of three single transmitting antennas, two transmitting antennas, and four transmitting antennas. When the base station uses the single transmitting antenna, a reference signal for a single antenna port is arrayed. When the base station uses two transmitting antennas, reference signals for two transmitting antenna ports are arrayed by using a time division multiplexing (TDM) scheme and/or a frequency division multiplexing (FDM) scheme. That is, different time resources and/or different frequency resources are allocated to the reference signals for two antenna ports which are distinguished from each other.

Moreover, when the base station uses four transmitting antennas, reference signals for four transmitting antenna ports are arrayed by using the TDM and/or FDM scheme. Channel information measured by a downlink signal receiving side (terminal) may be used to demodulate data transmitted by using a transmission scheme such as single transmitting antenna transmission, transmission diversity, closed-loop spatial multiplexing, open-loop spatial multiplexing, or multi-user MIMO.

In the case where the MIMO antenna is supported, when the reference signal is transmitted from a specific antenna port, the reference signal is transmitted to the positions of specific resource elements according to a pattern of the reference signal and not transmitted to the positions of the specific resource elements for another antenna port. That is, reference signals among different antennas are not duplicated with each other.

A rule of mapping the CRS to the resource block is defined as below.

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix} \\ {v}_{shift} = {N}_{ID}^{cell} mod 6 \qquad [ Equation 1 ]$$

In Equation 1, k and l represent the subcarrier index and the symbol index, respectively and p represents the antenna port. N_{symb}^{DL} represents the number of OFDM symbols in one downlink slot and N_{RB}^{DL} represents the number of radio resources allocated to the downlink. ns represents a slot index and, N_{ID}^{cell} represents a cell ID. mod represents an modulo operation. The position of the reference signal varies depending on the v_{shift} value in the frequency domain. Since v_{shift} is subordinated to the cell ID, the position of the reference signal has various frequency shift values according to the cell.

In more detail, the position of the CRS may be shifted in the frequency domain according to the cell in order to improve channel estimation performance through the CRS. For example, when the reference signal is positioned at an interval of three subcarriers, reference signals in one cell are allocated to a 3k-th subcarrier and a reference signal in another cell is allocated to a 3k+1-th subcarrier. In terms of one antenna port, the reference signals are arrayed at an interval of six resource elements in the frequency domain and separated from a reference signal allocated to another antenna port at an interval of three resource elements.

In the time domain, the reference signals are arrayed at a constant interval from symbol index 0 of each slot. The time interval is defined differently according to a cyclic shift length. In the case of the normal cyclic shift, the reference signal is positioned at symbol indexes 0 and 4 of the slot and in the case of the extended CP, the reference signal is positioned at symbol indexes 0 and 3 of the slot. A reference signal for an antenna port having a maximum value between two antenna ports is defined in one OFDM symbol. Therefore, in the case of transmission of four transmitting antennas, reference signals for reference signal antenna ports 0 and 1 are positioned at symbol indexes 0 and 4 (symbol indexes 0 and 3 in the case of the extended CP) and reference signals for antenna ports 2 and 3 are positioned at symbol index 1 of the slot. The positions of the reference signals for antenna ports 2 and 3 in the frequency domain are exchanged with each other in a second slot.

Hereinafter, when the DRS is described in more detail, the DRS is used for demodulating data. A precoding weight used for a specific terminal in the MIMO antenna transmission is used without a change in order to estimate a channel associated with and corresponding to a transmission channel transmitted in each transmitting antenna when the terminal receives the reference signal.

The 3GPP LTE system (for example, release-8) supports a maximum of four transmitting antennas and a DRS for rank 1 beamforming is defined. The DRS for the rank 1 beamforming also means a reference signal for antenna port index 5.

A rule of mapping the DRS to the resource block is defined as below. Equation 2 shows the case of the normal CP and Equation 3 shows the case of the extended CP.

$$\begin{matrix}k = ( {k}^{′} ) mod {N}_{sc}^{RB} + {N}_{sc}^{RB} \cdot {n}_{PRB} \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} \\ {l}^{′} = \{ \begin{matrix}0 , 1 & if {n}_{s} mod 2 = 0 \\ 2 , 3 & if {n}_{s} mod 2 = 1\end{matrix} \\ {m}^{′} = 0 , 1 , … , 3 {N}_{RB}^{PDSCH} - 1 \\ {v}_{shift} = {N}_{ID}^{cell} mod 3 & [ Equation 2 ] \\ k = ( {k}^{′} ) mod {N}_{sc}^{RB} + {N}_{sc}^{RB} \cdot {n}_{PRB} \\ {k}^{′} = \{ \begin{matrix}3 {m}^{′} + {v}_{shift} & if l = 4 \\ 3 {m}^{′} + ( 2 + {v}_{shift} ) mod 3 & if l = 1\end{matrix} \\ l = \{ \begin{matrix}4 & {l}^{′} ∈ \{ 0 , 2 \} \\ 1 & {l}^{′} = 1\end{matrix} \\ {l}^{′} = \{ \begin{matrix}0 & if {n}_{s} mod 2 = 0 \\ 1 , 2 & if {n}_{s} mod 2 = 1\end{matrix} \\ {m}^{′} = 0 , 1 , … , 4 {N}_{RB}^{PDSCH} - 1 \\ {v}_{shift} = {N}_{ID}^{cell} mod 3 & [ Equation 3 ]\end{matrix}$$

In Equations 2 and 3 given above, k and p represent the subcarrier index and the antenna port, respectively. N_{RB}^{DL}, ns, and N_{ID}^{cell} represent the number of RBs, the number of slot indexes, and the number of cell IDs allocated to the downlink, respectively. The position of the RS varies depending on the v_{shift} value in terms of the frequency domain.

In Equations 1 to 3, k and l represent the subcarrier index and the symbol index, respectively and p represents the antenna port. N_{sc}^{RB} represents the size of the resource block in the frequency domain and is expressed as the number of subcarriers. n_{PRB} represents the number of physical resource blocks. N_{RB}^{PDSCH} represents a frequency band of the resource block for the PDSCH transmission. ns represents the slot index and N_{ID}^{cell} represents the cell ID. mod represents the modulo operation. The position of the reference signal varies depending on the v_{shift} value in the frequency domain. Since v_{shift} is subordinated to the cell ID, the position of the reference signal has various frequency shift values according to the cell.

Sounding Reference Signal (SRS)

The SRS is primarily used for the channel quality measurement in order to perform frequency-selective scheduling and is not associated with transmission of the uplink data and/or control information. However, the SRS is not limited thereto and the SRS may be used for various other purposes for supporting improvement of power control and various start-up functions of terminals which have not been scheduled. One example of the start-up function may include an initial modulation and coding scheme (MCS), initial power control for data transmission, timing advance, and frequency semi-selective scheduling. In this case, the frequency semi-selective scheduling means scheduling that selectively allocates the frequency resource to the first slot of the subframe and allocates the frequency resource by pseudo-randomly hopping to another frequency in the second slot.

Further, the SRS may be used for measuring the downlink channel quality on the assumption that the radio channels between the uplink and the downlink are reciprocal. The assumption is valid particularly in the time division duplex in which the uplink and the downlink share the same frequency spectrum and are divided in the time domain.

Subframes of the SRS transmitted by any terminal in the cell may be expressed by a cell-specific broadcasting signal. A 4-bit cell-specific ‘srsSubframeConfiguration’ parameter represents 15 available subframe arrays in which the SRS may be transmitted through each radio frame. By the arrays, flexibility for adjustment of the SRS overhead is provided according to a deployment scenario.

A 16-th array among them completely turns off a switch of the SRS in the cell and is suitable primarily for a serving cell that serves high-speed terminals.

FIG. 11 illustrates an uplink subframe including a sounding reference signal symbol in the wireless communication system to which the present invention can be applied.

Referring to FIG. 11, the SRS is continuously transmitted through a last SC FDMA symbol on the arrayed subframes. Therefore, the SRS and the DMRS are positioned at different SC-FDMA symbols.

The PUSCH data transmission is not permitted in a specific SC-FDMA symbol for the SRS transmission and consequently, when sounding overhead is highest, that is, even when the SRS symbol is included in all subframes, the sounding overhead does not exceed approximately 7%.

Each SRS symbol is generated by a base sequence (random sequence or a sequence set based on Zadoff-Ch (ZC)) associated with a given time wise and a given frequency band and all terminals in the same cell use the same base sequence. In this case, SRS transmissions from a plurality of terminals in the same cell in the same frequency band and at the same time are orthogonal to each other by different cyclic shifts of the base sequence to be distinguished from each other.

SRS sequences from different cells may be distinguished from each other by allocating different base sequences to respective cells, but orthogonality between different base sequences is not secured.

General Carrier Aggregation

A communication environment considered in embodiments of the present invention includes multi-carrier supporting environments. That is, a multi-carrier system or a carrier aggregation system used in the present invention means a system that aggregates and uses one or more component carriers (CCs) having a smaller bandwidth smaller than a target band at the time of configuring a target wideband in order to support a wideband.

In the present invention, multi-carriers mean aggregation of (alternatively, carrier aggregation) of carriers and in this case, the aggregation of the carriers means both aggregation between continuous carriers and aggregation between non-contiguous carriers. Further, the number of component carriers aggregated between the downlink and the uplink may be differently set. A case in which the number of downlink component carriers (hereinafter, referred to as ‘DL CC’) and the number of uplink component carriers (hereinafter, referred to as ‘UL CC’) are the same as each other is referred to as symmetric aggregation and a case in which the number of downlink component carriers and the number of uplink component carriers are different from each other is referred to as asymmetric aggregation. The carrier aggregation may be used interchangeably with the term such as the carrier aggregation, the bandwidth aggregation, spectrum aggregation, or the like.

The carrier aggregation configured by combining two or more component carriers aims at supporting up to a bandwidth of 100 MHz in the LTE-A system. When one or more carriers having the bandwidth than the target band are combined, the bandwidth of the carriers to be combined may be limited to a bandwidth used in the existing system in order to maintain backward compatibility with the existing IMT system. For example, the existing 3GPP LTE system supports bandwidths of 1.4, 3, 5, 10, 15, and 20 MHz and a 3GPP LTE-advanced system (that is, LTE-A) may be configured to support a bandwidth larger than 20 MHz by using on the bandwidth for compatibility with the existing system. Further, the carrier aggregation system used in the preset invention may be configured to support the carrier aggregation by defining a new bandwidth regardless of the bandwidth used in the existing system.

The LTE-A system uses a concept of the cell in order to manage a radio resource.

The carrier aggregation environment may be called a multi-cell environment. The cell is defined as a combination of a pair of a downlink resource (DL CC) and an uplink resource (UL CC), but the uplink resource is not required. Therefore, the cell may be constituted by only the downlink resource or both the downlink resource and the uplink resource. When a specific terminal has only one configured serving cell, the cell may have one DL CC and one UL CC, but when the specific terminal has two or more configured serving cells, the cell has DL CCs as many as the cells and the number of UL CCs may be equal to or smaller than the number of DL CCs.

Alternatively, contrary to this, the DL CC and the UL CC may be configured. That is, when the specific terminal has multiple configured serving cells, a carrier aggregation environment having UL CCs more than DL CCs may also be supported. That is, the carrier aggregation may be appreciated as aggregation of two or more cells having different carrier frequencies (center frequencies). Herein, the described ‘cell’ needs to be distinguished from a cell as an area covered by the base station which is generally used.

The cell used in the LTE-A system includes a primary cell (PCell) and a secondary cell (SCell). The P cell and the S cell may be used as the serving cell. In a terminal which is in an RRC_CONNECTED state, but does not have the configured carrier aggregation or does not support the carrier aggregation, only one serving constituted by only the P cell is present. On the contrary, in a terminal which is in the RRC_CONNECTED state and has the configured carrier aggregation, one or more serving cells may be present and the P cell and one or more S cells are included in all serving cells.

The serving cell (P cell and S cell) may be configured through an RRC parameter. PhysCellId as a physical layer identifier of the cell has integer values of 0 to 503. SCellIndex as a short identifier used to identify the S cell has integer values of 1 to 7. ServCellIndex as a short identifier used to identify the serving cell (P cell or S cell) has the integer values of 0 to 7. The value of 0 is applied to the P cell and SCellIndex is previously granted for application to the S cell. That is, a cell having a smallest cell ID (alternatively, cell index) in ServCellIndex becomes the P cell.

The P cell means a cell that operates on a primary frequency (alternatively, primary CC). The terminal may be used to perform an initial connection establishment process or a connection re-establishment process and may be designated as a cell indicated during a handover process. Further, the P cell means a cell which becomes the center of control associated communication among serving cells configured in the carrier aggregation environment. That is, the terminal may be allocated with and transmit the PUCCH only in the P cell thereof and use only the P cell to acquire the system information or change a monitoring procedure. An evolved universal terrestrial radio access (E-UTRAN) may change only the P cell for the handover procedure to the terminal supporting the carrier aggregation environment by using an RRC connection reconfiguration message (RRCConnectionReconfigutaion) message of an upper layer including mobile control information (mobilityControlInfo).

The S cell means a cell that operates on a secondary frequency (alternatively, secondary CC). Only one P cell may be allocated to a specific terminal and one or more S cells may be allocated to the specific terminal. The S cell may be configured after RRC connection establishment is achieved and used for providing an additional radio resource. The PUCCH is not present in residual cells other than the P cell, that is, the S cells among the serving cells configured in the carrier aggregation environment. The E-UTRAN may provide all system information associated with a related cell which is in an RRC_CONNECTED state through a dedicated signal at the time of adding the S cells to the terminal that supports the carrier aggregation environment. A change of the system information may be controlled by releasing and adding the related S cell and in this case, the RRC connection reconfiguration (RRCConnectionReconfigutaion) message of the upper layer may be used. The E-UTRAN may perform having different parameters for each terminal rather than broadcasting in the related S cell.

After an initial security activation process starts, the E-UTRAN adds the S cells to the P cell initially configured during the connection establishment process to configure a network including one or more S cells. In the carrier aggregation environment, the P cell and the S cell may operate as the respective component carriers. In an embodiment described below, the primary component carrier (PCC) may be used as the same meaning as the P cell and the secondary component carrier (SCC) may be used as the same meaning as the S cell.

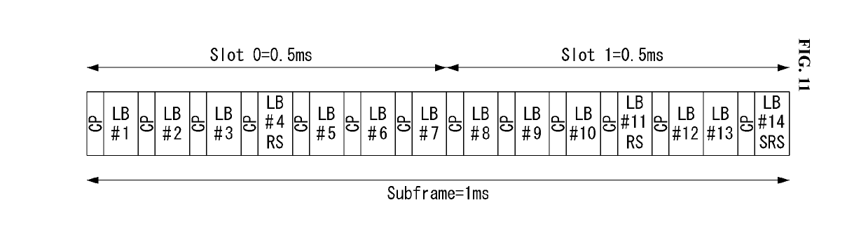

FIG. 12 illustrates examples of a component carrier and carrier aggregation in the wireless communication system to which the present invention can be applied.

FIG. 12 (a) illustrates a single carrier structure used in an LTE system. The component carrier includes the DL CC and the UL CC. One component carrier may have a frequency range of 20 MHz.

FIG. 12 (b) illustrates a carrier aggregation structure used in the LTE system. In the case of FIG. 12 (b), a case is illustrated, in which three component carriers having a frequency magnitude of 20 MHz are combined. Each of three DL CCs and three UL CCs is provided, but the number of DL CCs and the number of UL CCs are not limited. In the case of carrier aggregation, the terminal may simultaneously monitor three CCs, and receive downlink signal/data and transmit uplink signal/data.

When N DL CCs are managed in a specific cell, the network may allocate M (M≤N) DL CCs to the terminal. In this case, the terminal may monitor only M limited DL CCs and receive the DL signal. Further, the network gives L (L≤M≤N) DL CCs to allocate a primary DL CC to the terminal and in this case, UE needs to particularly monitor L DL CCs. Such a scheme may be similarly applied even to uplink transmission.

A linkage between a carrier frequency (alternatively, DL CC) of the downlink resource and a carrier frequency (alternatively, UL CC) of the uplink resource may be indicated by an upper-layer message such as the RRC message or the system information. For example, a combination of the DL resource and the UL resource may be configured by a linkage defined by system information block type 2 (SIB2). In detail, the linkage may mean a mapping relationship between the DL CC in which the PDCCH transporting a UL grant and a UL CC using the UL grant and mean a mapping relationship between the DL CC (alternatively, UL CC) in which data for the HARQ is transmitted and the UL CC (alternatively, DL CC) in which the HARQ ACK/NACK signal is transmitted.

Cross Carrier Scheduling

In the carrier aggregation system, in terms of scheduling for the carrier or the serving cell, two types of a self-scheduling method and a cross carrier scheduling method are provided. The cross carrier scheduling may be called cross component carrier scheduling or cross cell scheduling.

The cross carrier scheduling means transmitting the PDCCH (DL grant) and the PDSCH to different respective DL CCs or transmitting the PUSCH transmitted according to the PDCCH (UL grant) transmitted in the DL CC through other UL CC other than a UL CC linked with the DL CC receiving the UL grant.

Whether to perform the cross carrier scheduling may be UE-specifically activated or deactivated and semi-statically known for each terminal through the upper-layer signaling (for example, RRC signaling).

When the cross carrier scheduling is activated, a carrier indicator field (CIF) indicating through which DL/UL CC the PDSCH/PUSCH the PDSCH/PUSCH indicated by the corresponding PDCCH is transmitted is required. For example, the PDCCH may allocate the PDSCH resource or the PUSCH resource to one of multiple component carriers by using the CIF. That is, the CIF is set when the PDSCH or PUSCH resource is allocated to one of DL/UL CCs in which the PDCCH on the DL CC is multiply aggregated. In this case, a DCI format of LTE-A Release-8 may extend according to the CIF. In this case, the set CIF may be fixed to a 3-bit field and the position of the set CIF may be fixed regardless of the size of the DCI format. Further, a PDCCH structure (the same coding and the same CCE based resource mapping) of the LTE-A Release-8 may be reused.

On the contrary, when the PDCCH on the DL CC allocates the PDSCH resource on the same DL CC or allocates the PUSCH resource on a UL CC which is singly linked, the CIF is not set. In this case, the same PDCCH structure (the same coding and the same CCE based resource mapping) and DCI format as the LTE-A Release-8 may be used.

When the cross carrier scheduling is possible, the terminal needs to monitor PDCCHs for a plurality of DCIs in a control region of a monitoring CC according to a transmission mode and/or a bandwidth for each CC. Therefore, a configuration and PDCCH monitoring of a search space which may support monitoring the PDCCHs for the plurality of DCIs are required.

In the carrier aggregation system, a terminal DL CC aggregate represents an aggregate of DL CCs in which the terminal is scheduled to receive the PDSCH and a terminal UL CC aggregate represents an aggregate of UL CCs in which the terminal is scheduled to transmit the PUSCH. Further, a PDCCH monitoring set represents a set of one or more DL CCs that perform the PDCCH monitoring. The PDCCH monitoring set may be the same as the terminal DL CC set or a subset of the terminal DL CC set. The PDCCH monitoring set may include at least any one of DL CCs in the terminal DL CC set. Alternatively, the PDCCH monitoring set may be defined separately regardless of the terminal DL CC set. The DL CCs included in the PDCCH monitoring set may be configured in such a manner that self-scheduling for the linked UL CC is continuously available. The terminal DL CC set, the terminal UL CC set, and the PDCCH monitoring set may be configured UE-specifically, UE group-specifically, or cell-specifically.

When the cross carrier scheduling is deactivated, the deactivation of the cross carrier scheduling means that the PDCCH monitoring set continuously means the terminal DL CC set and in this case, an indication such as separate signaling for the PDCCH monitoring set is not required. However, when the cross carrier scheduling is activated, the PDCCH monitoring set is preferably defined in the terminal DL CC set. That is, the base station transmits the PDCCH through only the PDCCH monitoring set in order to schedule the PDSCH or PUSCH for the terminal.

FIG. 13 illustrates one example of a subframe structure depending on cross carrier scheduling in the wireless communication system to which the present invention can be applied.

Referring to FIG. 13, a case is illustrated, in which three DL CCs are associated with a DL subframe for an LTE-A terminal and DL CC‘A’ is configured as a PDCCH monitoring DL CC. When the CIF is not used, each DL CC may transmit the PDCCH scheduling the PDSCH thereof without the CIF. On the contrary, when the CIF is used through the upper-layer signaling, only one DL CC ‘A’ may transmit the PDCCH scheduling the PDSCH thereof or the PDSCH of another CC by using the CIF. In this case, DL CC ‘B’ and ‘C’ in which the PDCCH monitoring DL CC is not configured does not transmit the PDCCH.

PDCCH Transmission

An eNB determines a PDCCH format depending on a DCI to be transmitted to a UE and attaches cyclic redundancy check (CRC) to control information. The CRC is masked with a unique identifier (this is called a radio network temporary identifier (RNTI)) depending on the owner or use of the PDCCH. If the PDCCH is a PDCCH a specific UE, the CRC may be masked with a unique identifier of the UE, for example, a cell-RNTI (C-RNTI). Or if the PDCCH is a PDCCH for a paging message, the CRC may be masked with a paging indication identifier, for example, a paging-RNTI (P-RNTI). If the PDCCH is a PDCCH for system information, more specifically, a system information block (SIB), the CRC may be masked with a system information identifier, a system information RNTI (SI-RNTI). In order to indicate a random access response, that is, a response to the transmission of the random access preamble of the UE, the CRC may be masked with a random access-RNTI (RA-RNTI).

Next, the eNB generates coded data by performing channel coding on the control information to which the CRC has been added. In this case, the eNB may perform the channel coding at a code rate according to an MCS level. The eNB performs rate matching according to a CCE aggregation level allocated to a PDCCH format, and generates modulation symbols by modulating the coded data. In this case, a modulation rank according to the MCS level may be used. In modulation symbols forming one PDCCH, a CCE aggregation level may be one of 1, 2, 4 and 8. Thereafter, the eNB maps the modulation symbols to a physical resource element (CCE to RE mapping).

A plurality of PDCCHs may be transmitted within one subframe. That is, the control region of one subframe consists of a plurality of CCEs having indices 0˜N_{CCE,k}−1. In this case, N_{CCE,k} means a total number of CCEs within the control region of a k-th subframe. The UE monitors a plurality of PDCCHs every subframe.

In this case, the monitoring means that the UE attempts the decoding of each PDCCH depending on a PDCCH format that is monitored. In the control region allocated within a subframe, the eNB does not provide the UE with information regarding that where is a corresponding PDCCH. In order to receive a control channel transmitted by the eNB, the UE is unaware that its own PDCCH is transmitted at which CCE aggregation level or DCI format at which location. Accordingly, the UE searches the subframe for its own PDCCH by monitoring a set of PDCCH candidates. This is called blind decoding/detection (BD). Blind decoding refers to a method for a UE to de-mask its own UE identifier (UE ID) from a CRC part and to check whether a corresponding PDCCH is its own control channel by reviewing a CRC error.

In the active mode, the UE monitors a PDCCH every subframe in order to receive data transmitted thereto. In the DRX mode, the UE wakes up in the monitoring interval of a DRX period and monitors a PDCCH in a subframe corresponding to the monitoring interval. A subframe in which the monitoring of the PDCCH is performed is called a non-DRX subframe.

In order to receive a PDCCH transmitted to the UE, the UE needs to perform blind decoding on all of CCEs present in the control region of a non-DRX subframe. The UE is unaware that which PDCCH format will be transmitted, and thus has to decode all of PDCCHs at a CCE aggregation level until the blind decoding of the PDCCHs is successful within the non-DRX subframe. The UE needs to attempt detection at all of CCE aggregation levels until the blind decoding of a PDCCH is successful because it is unaware that the PDCCH for the UE will use how many CCEs. That is, the UE performs blind decoding for each CCE aggregation level. That is, the UE first attempts decoding by setting a CCE aggregation level unit to 1. If decoding fully fails, the UE attempts decoding by setting the CCE aggregation level unit to 2. Thereafter, the UE attempts decoding by setting the CCE aggregation level unit to 4 and setting the CCE aggregation level unit to 8. Furthermore, the UE attempts blind decoding on all of a C-RNTI, P-RNTI, SI-RNTI and RA-RNTI. Furthermore, the UE attempts blind decoding on all of DCI formats that need to be monitored.

As described above, if the UE performs blind decoding on all of possible RNTIs, all of DCI formats to be monitored and for each of all of CCE aggregation levels, the number of detection attempts is excessively many. Accordingly, in the LTE system, a search space (SS) concept is defined for the blind decoding of a UE. The search space means a PDCCH candidate set for monitoring, and may have a different size depending on each PDCCH format.

The search space may include a common search space (CSS) and a UE-specific/dedicated search space (USS). In the case of the common search space, all of UEs may be aware of the size of the common search space, but a UE-specific search space may be individually configured for each UE. Accordingly, in order to decode a PDCCH, a UE must monitor both the UE-specific search space and the common search space, and thus performs a maximum of 44 times of blind decoding (BD) in one subframe. This does not include blind decoding performed based on a different CRC value (e.g., C-RNTI, P-RNTI, SI-RNTI, RA-RNTI).

There may occur a case where an eNB cannot secure CCE resources for transmitting a PDCCH to all of UEs to which the PDCCH is to be transmitted within a given subframe due to a smaller search space. The reason for this is that resources left over after a CCE location is allocated may not be included in the search space of a specific UE. In order to minimize such a barrier that may continue even in a next subframe, a UE-specific hopping sequence may be applied to the point at which the UE-specific search space starts.

Table 4 shows the size of the common search space and the UE-specific search space.

TABLE 4

| PDCCH | Number of | Number of candidates | Number of candidates |
|---|---|---|---|
| format | CCEs (n) | in common search space | in dedicated search space |
| 0 | 1 | — | 6 |
| 1 | 2 | — | 6 |
| 2 | 4 | 4 | 2 |
| 3 | 8 | 2 | 2 |

In order to reduce a computational load of a UE according to the number of times that the UE attempts blind decoding, the UE does not perform search according to all of defined DCI formats at the same time. Specifically, the UE may always perform search for the DCI formats 0 and 1A in the UE-specific search space. In this case, the DCI formats 0 and 1A have the same size, but the UE may distinguish between the DCI formats using a flag for the DCI format 0/format 1A differentiation included in a PDCCH. Furthermore, a different DCI format in addition to the DCI formats 0 and 1A may be required for the UE depending on a PDSCH transmission mode configured by an eNB. For example, the DCI formats 1, 1B and 2 may be required for the UE.

The UE may search the common search space for the DCI formats 1A and 1C. Furthermore, the UE may be configured to search for the DCI format 3 or 3A. The DCI formats 3 and 3A have the same size as the DCI formats 0 and 1A, but the UE may distinguish between the DCI formats using CRS scrambled by another identifier other than a UE-specific identifier.

A search space Sₖ^{(L)} means a PDCCH candidate set according to an aggregation level Lϵ{1,2,4,8} A CCE according to the PDCCH candidate set m of the search space may be determined by Equation 4.

L·{(Yₖ+m)mod└N_{CCE,k}/L┘}+i [Equation 4]

In this case, M^{(L)} indicates the number of PDCCH candidates according to a CCE aggregation level L for monitoring in the search space, and m=0, Λ, M^{(L)}−1. i is an index for designating an individual CCE in each PDCCH candidate, and is i=0, Λ, L−1.

As described above, in order to decode a PDCCH, the UE monitors both the UE-specific search space and the common search space. In this case, the common search space (CSS) supports PDCCHs having an aggregation level of {4, 8}, and the UE-specific search space(USS) supports PDCCHs having an aggregation level of {1, 2, 4, 8}.

Table 5 shows DCCH candidates monitored by a UE.

TABLE 5

| Search space Sₖ^{(L)} | | | Number of PDCCH |
|---|---|---|---|
| Type | Aggregation level L | Size [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

Referring to Equation 4, in the case of the common search space, Yₖ is set to 0 with respect to two aggregation levels L=4 and L=8. In contrast, with respect to an aggregation level L, in the case of the UE-specific search space, Yₖ is defined as in Equation 5.

Yₖ=(A·Yₖ₋₁)mod D [Equation 5]

In this case, Y₋₁=n_{RNTI}≠0, and an RNTI value used for n_{RNTI} may be defined as one of the identifications of the UE. Furthermore, A=39827, D=65537, and k=└nₛ/2┘. In this case, nₛ indicates the slot number (or index) of a radio frame.

ACK/NACK Multiplexing Method

In a situation in which the terminal simultaneously needs to transmit multiple ACKs/NACKs corresponding to multiple data units received from an eNB, an ACK/NACK multiplexing method based on PUCCH resource selection may be considered in order to maintain a single-frequency characteristic of the ACK/NACK signal and reduce ACK/NACK transmission power.

Together with ACK/NACK multiplexing, contents of ACK/NACK responses for multiple data units may be identified by combining a PUCCH resource and a resource of QPSK modulation symbols used for actual ACK/NACK transmission.

For example, when one PUCCH resource may transmit 4 bits and four data units may be maximally transmitted, an ACK/NACK result may be identified in the eNB as shown in Table 6 given below.

TABLE 6

| HARQ-ACK(0), HARQ-ACK(1), | | b(0), |
|---|---|---|
| HARQ-ACK(2), HARQ-ACK(3) | n_{PUCCH}⁽¹⁾ | b(1) |
| ACK, ACK, ACK, ACK | n_{PUCCH, 1}⁽¹⁾ | 1, 1 |
| ACK, ACK, ACK, NACK/DTX | n_{PUCCH, 1}⁽¹⁾ | 1, 0 |
| NACK/DTX, NACK/DTX, NACK, DTX | n_{PUCCH, 2}⁽¹⁾ | 1, 1 |
| ACK, ACK, NACK/DTX, ACK | n_{PUCCH, 1}⁽¹⁾ | 1, 0 |
| NACK, DTX, DTX, DTX | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 0, 1 |
| NACK/DTX, NACK/DTX, NACK/DTX, NACK | n_{PUCCH, 3}⁽¹⁾ | 1, 1 |
| ACK, NACK/DTX, ACK, NACK/DTX | n_{PUCCH, 2}⁽¹⁾ | 0, 1 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 3}⁽¹⁾ | 0, 1 |
| NACK/DTX, NACK, DTX, DTX | n_{PUCCH, 1}⁽¹⁾ | 0, 0 |
| NACK/DTX, ACK, ACK, NACK/DTX | n_{PUCCH, 2}⁽¹⁾ | 1, 0 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| DTX, DTX, DTX, DTX | N/A | N/A |

In Table 6 given above, HARQ-ACK(i) represents an ACK/NACK result for an i-th data unit. In Table 6 given above, discontinuous transmission (DTX) means that there is no data unit to be transmitted for the corresponding HARQ-ACK(i) or that the terminal may not detect the data unit corresponding to the HARQ-ACK(i).

According to Table 6 given above, a maximum of four PUCCH resources (n_{PUCCH,0}⁽¹⁾, n_{PUCCH,1}⁽¹⁾, n_{PUCCH,2}⁽¹⁾, and n_{PUCCH,3}⁽¹⁾) are provided and b(0) and b(1) are two bits transmitted by using a selected PUCCH.

For example, when the terminal successfully receives all of four data units, the terminal transmits 2 bits (1,1) by using n_{PUCCH,0}⁽¹⁾.

When the terminal fails in decoding in first and third data units and succeeds in decoding in second and fourth data units, the terminal transmits bits (1,0) by using n_{PUCCH,3}⁽¹⁾.

In ACK/NACK channel selection, when there is at least one ACK, the NACK and the DTX are coupled with each other. The reason is that a combination of the PUCCH resource and the QPSK symbol may not all ACK/NACK states. However, when there is no ACK, the DTX is decoupled from the NACK.

In this case, the PUCCH resource linked to the data unit corresponding to one definite NACK may also be reserved to transmit signals of multiple ACKs/NACKs.

Block Spread Scheme

Unlike the existing PUCCH format 1 series or 2 series, a block spread scheme is a method for modulating control signal transmission using an SC-FDMA method. As shown in FIG. 14, a symbol sequence may be spread on the time domain using orthogonal cover code (OCC) and transmitted. The control signals of a plurality of UEs may be multiplexed on the same RB using the OCC. In the case of the PUCCH format 2, one symbol sequence is transmitted over the time domain, and the control signals of a plurality of UEs are multiplexed using a cyclic shift (CS) of a CAZAC sequence. In contrast, in the case of the block spread-based PUCCH format (e.g., PUCCH format 3), one symbol sequence is transmitted over the frequency domain, and the control signals of a plurality of UEs are multiplexed using the time domain spread using the OCC.

FIG. 14 illustrates one example of generating and transmitting 5 SC-FDMA symbols during one slot in the wireless communication system to which the present invention can be applied.

In FIG. 14, an example of generating and transmitting 5 SC-FDMA symbols (that is, data part) by using an OCC having the length of 5 (alternatively, SF=5) in one symbol sequence during one slot. In this case, two RS symbols may be used during one slot.

In the example of FIG. 14, the RS symbol may be generated from a CAZAC sequence to which a specific cyclic shift value is applied and transmitted in a type in which a predetermined OCC is applied (alternatively, multiplied) throughout a plurality of RS symbols. Further, in the example of FIG. 8, when it is assumed that 12 modulated symbols are used for each OFDM symbol (alternatively, SC-FDMA symbol) and the respective modulated symbols are generated by QPSK, the maximum bit number which may be transmitted in one slot becomes 24 bits (=12×2). Accordingly, the bit number which is transmittable by two slots becomes a total of 48 bits. When a PUCCH channel structure of the block spreading scheme is used, control information having an extended size may be transmitted as compared with the existing PUCCH format 1 series and 2 series.

Hybrid—Automatic Repeat and Request (HARQ)

In a mobile communication system, one eNB transmits/receives data to/from a plurality of UEs through a radio channel environment in one cell/sector.

In a system operating using multiple carriers and a similar form, an eNB receives packet traffic from the wired Internet and transmits the received packet traffic to each UE using a predetermined communication method. In this case, what the eNB determines to transmit data to which UE using which frequency domain at which timing is downlink scheduling.

Furthermore, the eNB receives and demodulates data transmitted by UEs using a communication method of a predetermined form, and transmits packet traffic to the wired Internet. What an eNB determines to transmit uplink data to which UEs using which frequency band at which timing is uplink scheduling. In general, a UE having a better channel state transmits/receives data using more time and more frequency resources.

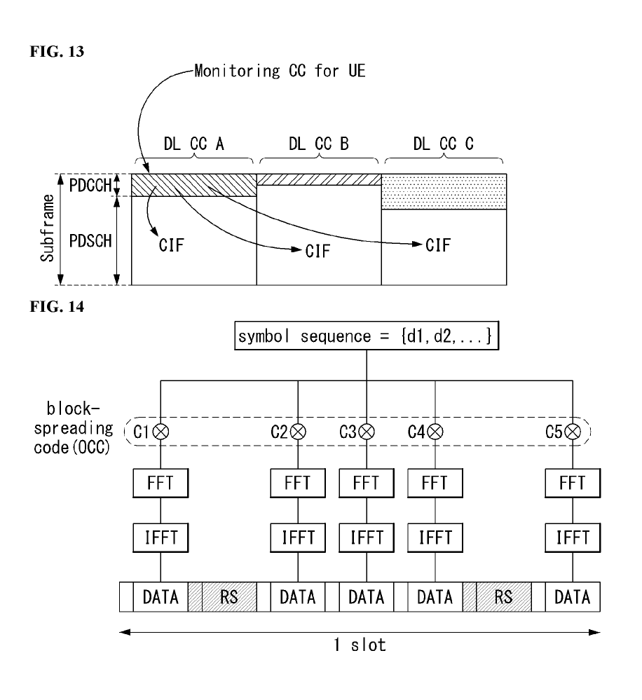

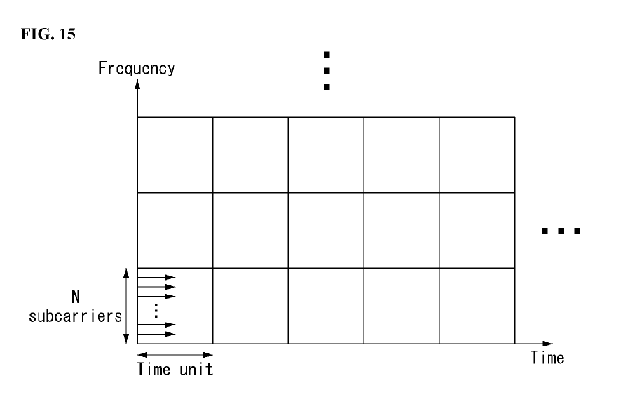

FIG. 15 is a diagram illustrating a time-frequency resource block in the time frequency domain of a wireless communication system to which the present invention may be applied.

Resources in a system using multiple carriers and a similar form may be basically divided into time and frequency domains. The resources may be defined as a resource block. The resource block includes specific N subcarriers and specific M subframes or a predetermined time unit. In this case, N and M may be 1.

In FIG. 15, one rectangle means one resource block, and one resource block includes several subcarriers in one axis and a predetermined time unit in the other axis. In the downlink, an eNB schedules one or more resource block for a selected UE according to a predetermined scheduling rule, and the eNB transmits data to the UE using the allocated resource blocks. In the uplink, the eNB schedules one or more resource block for a selected UE according to a predetermined scheduling rule, and UEs transmits data using the allocated resources in the uplink.

After data is transmitted after scheduling, an error control method if a frame is lost or damaged includes an automatic repeat request (ARQ) method and a hybrid ARQ (HARQ) method of a more advanced form.

Basically, in the ARQ method, after one frame transmission, the reception side waits for an acknowledgement message (ACK). The reception side transmits an acknowledgement message (ACK) only when a message is properly received. If an error is generated in a frame, the reception side transmits a negative-ACK (NACK) message and deletes information about the erroneously received frame from a reception stage buffer. A transmission side transmits a subsequent frame when it receives an ACK signal is received, but retransmits the frame when it receives a NACK message.

Unlike in the ARQ method, in the HARQ method, if a received frame cannot be demodulated, the reception stage transmits a NACK message to the transmission stage, but stores the received frame in the buffer for a specific time, and combines the stored frame with a previously received frame when the frame is retransmitted, thereby increasing a reception success rate.

Recently, a more efficient HARQ method than the basic ARQ method is widely used. In addition to the HARQ method, several types are present. The HARQ method may be divided into synchronous HARQ and asynchronous HARQ depending on timing for retransmission. With respect to the amount of resources used upon retransmission, the method may be divided into a channel-adaptive method and a channel-non-adaptive method depending on whether a channel state is incorporated or not.

The synchronous HARQ method is a method in which subsequent retransmission is performed by a system at predetermined timing when initial transmission fails. That is, assuming that timing at which retransmission is performed every fourth time unit after the initial transmission fails, since an agreement has been previously made between an eNB and UEs, it is not necessary to additionally provide notification of the timing. However, if the data transmission side has received a NACK message, a frame is retransmitted every fourth time unit until an ACK message is received.

In contrast, in the asynchronous HARQ method, retransmission timing may be newly scheduled or may be performed through additional signaling. Timing at which retransmission for a previously failed frame varies due to several factors, such as a channel state.

The channel-non-adaptive HARQ method is a method in which upon retransmission, the modulation of a frame or the number of resource blocks used or adaptive modulation and coding (ACM) is performed as predetermined upon initial transmission. Unlike in the channel-non-adaptive HARQ method, the channel-adaptive HARQ method is a method in which they vary depending on the state of a channel. For example, in the channel-non-adaptive HARQ method, a transmission side transmitted data using six resource blocks upon initial transmission and retransmits data using six resource blocks likewise even upon retransmission. In contrast, although transmission has been performed using 6 resource blocks at the early stage, a method of performing retransmission using resource blocks greater than or smaller than 6 depending on a channel state is a channel-adaptive HARQ method.

Four combinations of HARQ may be performed based on such classification, but a chiefly used HARQ method includes an asynchronous channel-adaptive asynchronous, a channel-adaptive HARQ (HARQ) method, and a synchronous and channel-non-adaptive HARQ method.

The asynchronous channel-adaptive HARQ method can maximize retransmission efficiency because retransmission timing and the amount of resources used are adaptively made different depending on the state of a channel, but is not generally taken into consideration because it has a disadvantage in that it has increasing overhead.

Meanwhile, the synchronous channel-non-adaptive HARQ method has an advantage in that there is almost no overhead because timing and resource allocation for retransmission have been agreed within a system, but has a disadvantage in that retransmission efficiency is very low if it is used in a channel state in which a change is severe.

FIG. 16 is a diagram illustrating a resources allocation and retransmission process of an asynchronous HARQ method in a wireless communication system to which the present invention may be applied.

Meanwhile, for example, in the case of the downlink, after data is transmitted after scheduling, ACK/NACK information is received from a UE, and time delay is generated after next data is transmitted as in FIG. 16. The delay is delay generated due to channel propagation delay and the time taken for data decoding and data encoding.

For non-empty data transmission during such a delay interval, a transmission method using an independent HARQ process is used. For example, if the shortest period between next data transmission and next data transmission is 7 subframes, data transmission can be performed without an empty space if 7 independent processes are placed.

An LTE physical layer supports HARQ in a PDSCH and PUSCH and transmits associated reception ACK feedback in a separate control channel.

If the LTE FDD system does not operate in MIMO, 8 stop-and-wait (SAW) HARQ processes are supported both in the uplink and downlink as a constant round-trip time (RTT) of 8 ms.

CA-Based CoMP Operation

In the LTE-post system, cooperative multi-point (CoMP) transmission may be implemented using a carrier aggregation (CA) function in LTE.

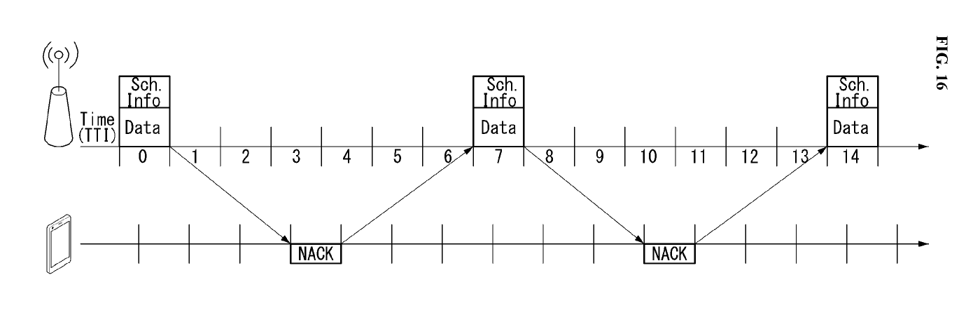

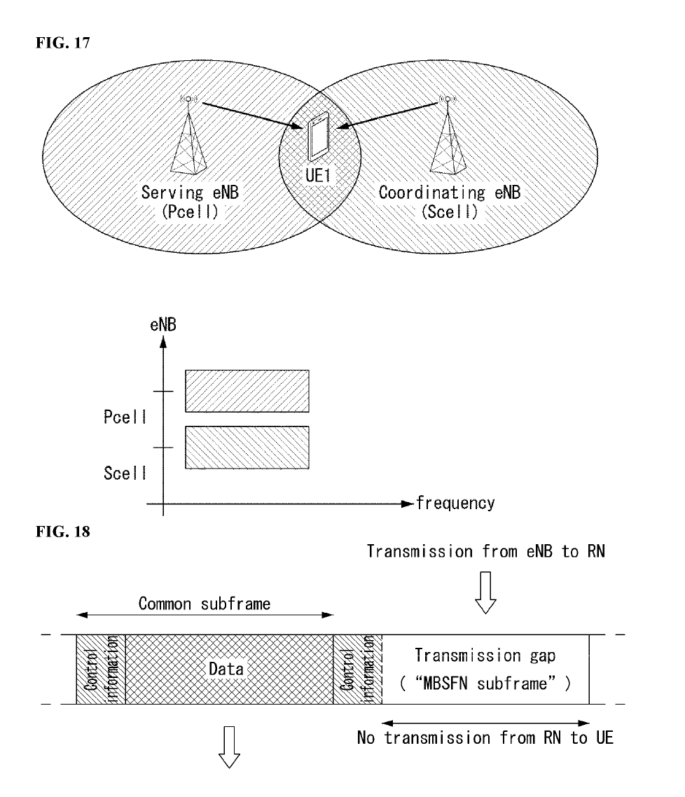

FIG. 17 is a diagram illustrating a carrier aggregation-based CoMP system in a wireless communication system to which the present invention may be applied.

FIG. 17 illustrates a case where a primary cell (PCell) carrier and a secondary cell (SCell) carrier are allocated to two eNBs that use the same frequency band in a frequency axis and are geographically spaced apart, respectively.

Various DL/UL CoMP operations, such as JT, CS/CB, and dynamic cell selection, may be possible in such a manner that a serving eNB assigns the PCell to a UE1 and assign an SCell, to an adjacent eNB having great interference.

FIG. 17 shows an example in which a UE merges the two eNBs as a PCell and an SCell, respectively. However, one UE may merge 3 or more cells. Some of the cells may perform a CoMP operation in the same frequency band and other cells may perform a simple CA operation in another frequency band. In this case, the PCell does not need to necessarily participate in the CoMP operation.

UE Procedure for PDSCH Reception

When a UE detects the PDCCH of a serving cell in which a DCI format 1, 1A, 1B, 1C, 1D, 2, 2A, 2B or 2C intended therefor is delivered within a subframe other than a subframe(s) indicated by a high layer parameter “mbsfn-SubframeConfigList”, it decodes a corresponding PDSCH in the same subframe due to a limit of the number of transport blocks defined in a high layer.

It is assumed that the UE decodes a PDSCH according to the detected PDCCH carrying the DCI format 1A or 1C intended therefor and having CRC scrambled by an SI-RNTI or P-RNTI and a PRS is not present in a resource block (RB) in which the corresponding PDSCH is delivered.

It is assumed that in the UE in which a carrier indication field (CIF) for a serving cell is configured, a carrier indication field is not present in any PDCCH of the serving cell within a common search space.

If not, it is assumed that when PDCCH CRC is scrambled by the C-RNTI or SPS C-RNTI, in a UE in which a CIF is configured, a CIF for the serving cell is present in a PDCCH located within a UE-specific search space.

When the UE is configured by a high layer so that it decodes a PDCCH having CRC scrambled by an SI-RNTI, the UE decodes the PDCCH and the corresponding PDSCH according to a combination defined in Table 7. The PDSCH corresponding to the PDCCH(s) is subjected to scrambling initialization by the SI-RNTI.

Table 7 illustrates the PDCCH and PDSCH configured by the SI-RNTI.

TABLE 7

| | | PDSCH transmission method |
|---|---|---|
| DCI format | Search space | corresponding to a PDCCH |
| DCI format 1C | Common | If the number of PBCH antenna |
| | | ports is 1, a single antenna |
| | | port, a port 0 is used, |
| | | and if not, transmit diversity |
| DCI format 1A | Common | If the number of PBCH antenna |
| | | ports is 1, a single antenna |
| | | port, a port 0 is used, |
| | | and if not, transmit diversity |

If the UE is configured by a high layer so that it decodes a PDCCH having CRC scrambled by a P-RNTI, the UE decodes the PDCCH and a corresponding PDSCH according to a combination defined in Table 8. The PDSCH corresponding to the PDCCH(s) is subjected to scrambling initialization by the P-RNTI.

Table 8 illustrates the PDCCH and PDSCH configured by the P-RNTI.

TABLE 8

| | | PDSCH transmission method |
|---|---|---|
| DCI format | Search space | corresponding to a PDCCH |
| DCI format 1C | Common | If the number of PBCH antenna |
| | | ports is 1, a single antenna |
| | | port, port 0 is used, |
| | | and if not, transmit diversity |
| DCI format 1A | Common | If the number of PBCH antenna |
| | | ports is 1, a single antenna |
| | | port, port 0 is used, |
| | | and if not, transmit diversity |

If the UE is configured by a high layer so that it decodes a PDCCH having CRC scrambled by an RA-RNTI, the UE decodes the PDCCH and a corresponding PDSCH according to a combination defined in Table 9. The PDSCH corresponding to the PDCCH(s) is subjected to scrambling initialization by the RA-RNTI.

Table 9 illustrates the PDCCH and PDSCH scrambled by the RA-RNTI.

TABLE 9

| | | PDSCH transmission method |
|---|---|---|
| DCI format | Search space | corresponding to PDCCH |
| DCI format 1C | Common | If the number of PBCH antenna |
| | | ports is 1, a single antenna |
| | | port, port 0 is used, |
| | | and if not, transmit diversity |
| DCI format 1A | Common | If the number of PBCH antenna |
| | | ports is 1, a single antenna |
| | | port, port 0 is used, |
| | | and if not, transmit diversity |

The UE may be semi-statically configured through higher layer signaling so that it receives PDSCH data transmission signaled through a PDCCH according to one of nine transmission modes, such as a mode 1 to a mode 9.

In the case of a frame architecture type 1,
A UE does not receive a PDSCH RB transmitted in the antenna port 5 within any subframe in which the number of OFDM symbols for a PDCCH having a normal CP is 4.
If any one of 2 physical resource blocks (PRBs) to which a virtual resource block (VRB) pair is mapped overlaps a frequency in which a PBCH or a primary or secondary synchronization signal is transmitted within the same subframe, a UE does not receive a PDSCH RB transmitted in the antenna port 5, 7, 8, 9, 10, 11, 12, 13 or 14 in the corresponding 2 PRBs.
A UE does not receive a PDSCH RB transmitted in the antenna port 7 to which distributed VRB resource allocation has been assigned.
If a UE does not receive all of allocated PDSCH RBs, it may skip the decoding of a transport block. If the UE skip decoding, a physical layer indicates a high layer that a transport block has not been successfully.

In the case of a frame architecture type 2,
A UE does not receive a PDSCH RB transmitted in the antenna port 5 within any subframe in which the number of OFDM symbols for a PDCCH having a normal CP is 4.
If any one of two PRBs to which a VRB pair is mapped overlaps a frequency in which a PBCH is transmitted within the same subframe, a UE does not receive a PDSCH RB in the antenna port 5 transmitted in the corresponding two PRBs.
If any one of two PRBs to which a VRB pair is mapped overlaps a frequency in which a primary or secondary synchronization signal is transmitted in the same subframe, a UE does not receive a PDSCH RB transmitted in the antenna port 7, 8, 9, 10, 11, 12, 13 or 14 in the corresponding two PRBs.
I a normal CP is configured, a UE does not receive in the antenna port 5 PDSCH to which VRB resource allocation distributed within a special subframe has been assigned in an uplink-downlink configuration #1 or #6.
A UE does not receive a PDSCH in the antenna port 7 to which distributed VRB resource allocation has been assigned.
If a UE does not receive all of allocated PDSCH RB, it may skip the decoding of a transport block. If the UE skips decoding, a physical layer indicates a high layer that a transport block has not been successfully decoded.

If a UE is configured by a high layer so that it decodes a PDCCH having CRC scrambled by a C-RNTI, the UE decodes the PDCCH and a corresponding PDSCH according to each combination defined in Table 10. The PDSCH corresponding to the PDCCH(s) is subjected to scrambling initialization by the C-RNTI.

If a CIF for a serving cell is configured or a UE is configured by a high layer so that it decodes a PDCCH having CRC scrambled by a C-RNTI, the UE decodes the PDSCH of a serving cell indicated by a CIF value within a decoded PDCCH.

If a UE of the transmission mode 3, 4, 8 or 9 receives DCI format 1A assignment, the UE assumes that PDSCH transmission is related to a transport block 1 and a transport block 2 is disabled.

If a UE is configured in the transmission mode 7, a UE-specific reference signal corresponding to a PDCCH(s) is subjected to scrambling initialization by a C-RNTI.

If an extended CP is used in the downlink, a UE does not support the transmission mode 8.

If the transmission mode 9 is configured for a UE, when the UE detects a PDCCH carrying the DCI format 1A or 2C intended therefor and having CRC scrambled by a C-RNTI, the UE decodes a corresponding PDSCH in a subframe indicated by a high layer parameter (“mbsfn-SubframeConfigList”). However, the UE is configured by a high layer so that it decodes a PMCH, or a PRS occasion is configured only within an MBSFN subframe and a subframe in which a CP length used in a subframe #0 is a normal CP and a subframe used as part of a PRS occasion by a high layer is excluded.

Table 10 illustrates a PDCCH and PDSCH configured by a C-RNTI.

TABLE 10

| Transmission | DCI | | PDSCH transmission method |
|---|---|---|---|
| mode | format | Search space | corresponding to PDCCH |
| Mode 1 | DCI | Common and UE- | Single antenna port, port 0 |
| | format | specific by | |
| | 1A | C-RNTI | |
| | DCI | UE-specific by | Single antenna port, port 0 |
| | format | C-RNTI | |
| | 1 | | |
| Mode 2 | DCI | Common and UE- | Transmit diversity |
| | format | specific by | |
| | 1A | C-RNTI | |
| | DCI | UE-specific by | Transmit diversity |
| | format | C-RNTI | |
| | 1 | | |
| Mode 3 | DCI | Common and UE- | Transmit diversity |
| | format | specific by | |
| | 1A | C-RNTI | |
| | DCI | UE-specific by | Large delay CDD or transmit |
| | format | C-RNTI | diversity |
| | 2A | | |
| Mode 4 | DCI | Common and UE- | Transmit diversity |
| | format | specific by | |
| | 1A | C-RNTI | |
| | DCI | UE-specific by | Closed-loop spatial |
| | format | C-RNTI | multiplexing or transmit |
| | 2 | | diversity |
| Mode 5 | DCI | Common and UE- | Transmit diversity |
| | format | specific by | |
| | 1A | C-RNTI | |
| | DCI | UE-specific by | Multi-user MIMO |
| | format | C-RNTI | |
| | 1D | | |
| Mode 6 | DCI | Common and UE- | Transmit diversity |
| | format | specific by | |
| | 1A | C-RNTI | |
| | DCI | UE-specific by | Closed-loop spatial |
| | format | C-RNTI | multiplexing using single |
| | 1B | | transport layer |
| Mode 7 | DCI | Common and UE- | If the number of PBCH |
| | format | specific by | antenna ports is 1, a single |
| | 1A | C-RNTI | antenna port, port 0 is used, |
| | | | and if not, transmit diversity |
| | DCI | UE-specific by | Single antenna port, port 5 |
| | format | C-RNTI | |
| | 1 | | |
| Mode 8 | DCI | Common and UE- | If the number of PBCH |
| | format | specific by a | antenna ports is 1, a single |
| | 1A | C-RNTI | antenna port, port 0 is used, |
| | | | and if not, transmit diversity |
| | DCI | UE-specific by | Dual layer transmission, ports |
| | format | C-RNTI | 7 and 8 or a single antenna |
| | 2B | | port, port 7 or 8 |
| Mode 9 | DCI | Common and UE- | Non-MBSFN subframe: if |
| | format | specific by a | the number of PBCH antenna |
| | 1A | C-RNTI | ports is 1, a single antenna |
| | | | port, port 0 is used, and if |
| | | | not, transmit diversity |
| | | | MBSFN subframe: a single |
| | | | antenna port, port 7 |
| | DCI | UE-specific by | Layer transmission of |
| | format | C-RNTI | maximum 8, port 7-14 |
| | 2C | | |

If a UE is configured by a high layer so that it decodes a PDCCH having SPS CRC scrambled by a C-RNTI, the UE decodes the PDCCH of a primary cell and the corresponding PDSCH of the primary cell according to each combination defined in Table 11. If the PDSCH is transmitted without the corresponding PDCCH, the same PDSCH-related configuration is applied. A PDSCH corresponding to the PDCCH and a PDSCH not having a PDCCH are subjected to scrambling initialization by an SPS C-RNTI.

If the transmission mode 7 is configured for a UE, a UE-specific reference signal corresponding to a PDCCH(s) is subjected to scrambling initialization by an SPS C-RNTI.

If the transmission mode 9 is configured for a UE, when the UE detects a PDCCH carrying the DCI format 1A or 2C intended therefor and having SPS CRC scrambled by a C-RNTI or a configured PDSCH configured without a PDCCH intended therefor, the UE decodes the corresponding PDSCH in a subframe indicated by a high layer parameter (“mbsfn-SubframeConfigList”). In this case, the UE is configured by a high layer so that it decodes a PMCH, or a PRS occasion is configured only within an MBSFN subframe, and a subframe in which a CP length used in a subframe #0 is a normal CP and configured as part of a PRS occasion by a high layer is excluded.

Table 11 illustrates a PDCCH and PDSCH configured by an SPS C-RNTI.

TABLE 11

| Transmission | DCI | | PDSCH transmission method |
|---|---|---|---|
| mode | format | Search space | corresponding to PDCCH |
| Mode 1 | DCI | Common and UE- | Single antenna port, port 0 |
| | format | specific by | |
| | 1A | C-RNTI | |
| | DCI | UE-specific by | Single antenna port, port 0 |
| | format | C-RNTI | |
| | 1 | | |
| Mode 2 | DCI | Common and UE- | Transmit diversity |
| | format | specific by | |
| | 1A | C-RNTI | |
| | DCI | UE-specific by | Transmit diversity |
| | format | C-RNTI | |
| | 1 | | |
| Mode 3 | DCI | Common and UE- | Transmit diversity |
| | format | specific by | |
| | 1A | C-RNTI | |
| | DCI | UE-specific by | Transmit diversity |
| | format | C-RNTI | |
| | 2A | | |
| Mode 4 | DCI | Common and UE- | Transmit diversity |
| | format | specific by | |
| | 1A | C-RNTI | |
| | DCI | UE-specific by | Transmit diversity |
| | format | C-RNTI | |
| | 2 | | |
| Mode 5 | DCI | Common and UE- | Transmit diversity |
| | format | specific by | |
| | 1A | C-RNTI | |
| Mode 6 | DCI | Common and UE- | Transmit diversity |
| | format | specific by | |
| | 1A | C-RNTI | |
| Mode 7 | DCI | Common and UE- | Single antenna port, port 5 |
| | format | specific by | |
| | 1A | C-RNTI | |
| | DCI | UE-specific by | Single antenna port, port 5 |
| | format | C-RNTI | |
| | 1 | | |
| Mode 8 | DCI | Common and UE- | Single antenna port, port 7 |
| | format | specific by | |
| | 1A | C-RNTI | |
| | DCI | UE-specific by | Single antenna port, port 7 |
| | format | C-RNTI | or 8 |
| | 2B | | |
| Mode 9 | DCI | Common and UE- | Single antenna port, port 7 |
| | format | specific by | |
| | 1A | C-RNTI | |
| | DCI | UE-specific by | Single antenna port, port 7 |
| | format | C-RNTI | or 8 |
| | 2C | | |

If a UE is configured by a high layer so that it decodes a PDCCH having CRC scrambled by a temporary C-RNTI and is configured so that it does not decode a PDCCH having CRC scrambled by the C-RNTI, the UE decodes the PDCCH and a corresponding PDSCH according to a combination defined in Table 12. The PDSCH corresponding to the PDCCH(s) is subjected to scrambling initialization by the temporary C-RNTI.

Table 12 illustrates the PDCCH and PDSCH configured by a temporary C-RNTI.

TABLE 12

| | | PDSCH transmission method |
|---|---|---|
| DCI format | Search space | corresponding to PDCCH |
| DCI format 1A | Common and UE- | If the number of PBCH |
| | specific by | antenna ports is 1, a |
| | temporary | single antenna port, |
| | C-RNTI | port 0 is used, and if |
| | | not, transmit diversity |
| DCI format 1 | UE-specific | If the number of PBCH |
| | by temporary | antenna ports is 1, a |
| | C-RNTI | single antenna port, |
| | | port 0 is used, and if |
| | | not, transmit diversity |

UE Procedure for PUSCH Transmission

A UE is semi-statically configured through higher layer signaling so that it performs PUSCH transmission signaled through a PDCCH according to any one of two uplink transmission modes of the mode 1 and 2 defined in Table 13. When the UE is configured by a high layer so that it decodes a PDCCH having CRC scrambled by a C-RNTI, the UE decodes the PDCCH according to a combination defined in Table 13 and transmits the corresponding PUSCH. PUSCH transmission corresponding to the PDCCH(s) and PUSCH retransmission for the same transport block are subjected to scrambling initialization by the C-RNTI. The transmission mode 1 is a default uplink transmission mode for the UE until the uplink transmission mode is assigned to the UE by higher layer signaling.

If the transmission mode 2 is configured for a UE and the UE receives a DCI format 0 uplink scheduling grant, the UE assumes that PUSCH transmission is related to a transport block 1 and a transport block 2 is disabled.

Table 13 illustrates the PDCCH and PUSCH configured by the C-RNTI.

TABLE 13

| | | | Transmission method of |
|---|---|---|---|
| Transmission | | | PUSCH corresponding |
| mode | DCI format | Search space | to PDCCH |
| Mode 1 | DCI format | Common and UE- | Single antenna port, |
| | 0 | specific by | port 10 |
| | | C-RNTI | |
| Mode 2 | DCI format | Common and UE- | Single antenna port, |
| | 0 | specific by | port 10 |
| | | C-RNTI | |
| | DCI format | UE-specific | Closed-loop spatial |
| | 4 | by C-RNTI | multiplexing |

If a UE is configured by a high layer so that it decodes a PDCCH having CRC scrambled by a C-RNTI and receives a random access procedure initiated by a PDCCH order, the UE decodes the PDCCH according to a combination defined in Table 14.

Table 14 illustrates the PDCCH configured by a PDCCH order for initiating a random access procedure.

TABLE 14

| DCI format | Search space |
|---|---|
| DCI format 1A | Common and UE-specific by C-RNTI |

If a UE is configured by a high layer so that it decodes a PDCCH having SPS CRC scrambled by a C-RNTI, the UE decodes the PDCCH according to a combination defined in Table 15 and transmits a corresponding PUSCH. PUSCH transmission corresponding to the PDCCH(s) and PUSCH retransmission for the same transport block are subjected to scrambling initialization by the SPS C-RNTI. Minimum transmission of the PUSCH and PUSCH retransmission for the same transport block without the corresponding PDCCH is subjected to scrambling initialization by the SPS C-RNTI.

Table 15 illustrates the PDCCH and PUSCH configured by the SPS C-RNTI.

TABLE 15

| | | | Transmission method of |
|---|---|---|---|
| Transmission | | | PUSCH corresponding |
| mode | DCI format | Search space | to PDCCH |
| Mode 1 | DCI format | Common and UE- | Single antenna |
| | 0 | specific by C- | port, port 10 |
| | | RNTI | |
| Mode 2 | DCI format | Common and UE- | Single antenna |
| | 0 | specific by C- | port, port 10 |
| | | RNTI | |

Regardless of whether a UE has been configured to decode a PDCCH having CRC scrambled by a C-RNTI, if the UE is configured by a high layer so that it decodes a PDCCH scrambled by a temporary C-RNTI, the UE decodes the PDCCH according to a combination defined in Table 16 and transmits the corresponding PUSCH. A PUSCH corresponding to the PDCCH(s) is subjected to scrambling initialization by the temporary C-RNTI.

If the temporary C-RNTI is set by a high layer, PUSCH transmission corresponding to a random access response grant and PUSCH retransmission for the same transport block are scrambled by the temporary C-RNTI. If not, PUSCH transmission corresponding to a random access response grant and PUSCH retransmission for the same transport block are scrambled by a C-RNTI.

Table 16 illustrates the PDCCH configured by the temporary C-RNTI.

TABLE 16

| DCI format | Search space |
|---|---|
| DCI format 0 | Common |

If a UE is configured by a high layer so that it decodes a PDCCH having CRC scrambled by a TPC-PUCCH-RNTI, the UE decodes the PDCCH according to a combination defined in Table 17. The indication of 3/3A in Table 17 includes that the UE receives the DCI format 3 or DCI format according to the configuration.

Table 17 illustrates the PDCCH configured by the TPC-PUCCH-RNTI.

TABLE 17

| DCI format | Search space |
|---|---|
| DCI formats 3/3A | Common |

If a UE is configured by a high layer so that it decodes a PDCCH having CRS scrambled by a TPC-PUSCH-RNTI, the UE decodes the PDCCH according to a combination defined in Table 18. The indication of 3/3A in Table 18 includes that the UE receives the DCI format 3 or DCI format according to the configuration.

Table 18 illustrates the PDCCH configured by the TPC-PUSCH-RNTI.

TABLE 18

| DCI format | Search space |
|---|---|
| DCI formats 3/3A | Common |

Relay Node (RN)

A relay node delivers data transmitted/received between an eNB and a UE through two different links (backhaul link and access link). The eNB may include a donor cell. The relay node is wirelessly connected to a wireless access network through the donor cell.

Meanwhile, in relation to the band (or spectrum) use of a relay node, a case where a backhaul link operates in the same frequency band as an access link and is called an “in-band”, and a case where the backhaul link and the access link operate in different frequency bands is called an “out-band.” In both the in-band and the out-band, a UE operating according to the existing LTE system (e.g., Release-8) (hereinafter referred to as a “legacy UE”) is capable of accessing a donor cell.

A relay node may be divided into a transparent relay node or a non-transparent relay node depending on whether a UE recognizes the relay node. Transparent means a case where whether a UE communicates with a network through a relay node is not recognized. Non-transparent means a case where whether a UE communicates with a network through a relay node is recognized.

In relation to control of a relay node, the relay node may be divided into a relay node configured as part of a donor cell and a relay node that autonomously controls a cell.

A relay node configured as part of a donor cell may have a relay node identifier (relay ID), but does not have the cell identity of the relay node itself.

If at least part of radio resource management (RRM) is controlled by an eNB to which a donor cell belongs, although the remaining parts of the RRM are located in a relay node, it is called a relay node configured as part of the donor cell. Preferably, such a relay node may support a legacy UE. For example, various types of smart repeaters, decode-and-forward relays, and L2 (second layer) relay nodes and a type-2 relay node correspond to such a relay node.

In the case of a relay node that autonomously controls a cell, the relay node controls one cell or a plurality of cells, and a unique physical layer cell identity is provided to each of cells controlled by the relay node. Furthermore, the cells controlled by the relay node may use the same RRM mechanism. From a viewpoint of a UE, there is no difference between a case where a UE accesses a cell controlled by a relay node and a UE accesses a cell controlled by a common eNB. A cell controlled by such a relay node may support a legacy UE. For example, a self-backhauling relay node, an L3 (third layer) relay node, a type-1 relay node and a type-1a relay node correspond to such a relay node.

A type-1 relay node is an in-band relay node and controls a plurality of cells. Each of the plurality of cells seems to be a separate cell different from a donor cell from a viewpoint of a UE. Furthermore, a plurality of cells has respective physical cell IDs (this is defined in LTE Release-8), and the relay node may transmit its own synchronization channel, a reference signal, etc. In the case of a single-cell operation, a UE may directly receive scheduling information and HARQ feedback from a relay node and transmit its own control channel (scheduling request (SR), CQI, ACK/NACK, etc.) to a relay node. Furthermore, the type-1 relay node seems to be a legacy eNB (an eNB operating according to the LTE Release-8 system) from a viewpoint of legacy UEs (UEs operating according to the LTE Release-8 system). That is, the type-1 relay node has (backward compatibility. Meanwhile, from a viewpoint of UEs operating according to the LTE-A systems, the type-1 relay node seems to be an eNB different from a legacy eNB, and can provide performance improvement.

In addition to a case where the type-1a relay node operates in an out-band, it has the same characteristics as the type-1 relay node. The operation of the type-1a relay node may be configured so that an influence attributable to an L1 (first layer) operation is minimized or not present.

A type-2 relay node is an in-band relay node and does not have a separate physical cell ID and thus does not form a new cell. The type-2 relay node is transparent to a legacy UE, and the legacy UE does not recognize the presence of the type-2 relay node. The type-2 relay node may transmit a PDSCH, but does not transmit a CRS and PDCCH at least.

Meanwhile, in order for a relay node to operate in the in-band, some resources in the time-frequency space must be reserved for a backhaul link, and the resources may be configured so that they are not used for an access link. This is called resources partitioning.

A common principle in resources partitioning in a relay node may be described as follows. Backhaul downlink and access downlink may be multiplexed on one carrier frequency according to a time division multiplexing (TDM) method (i.e., only one of the backhaul downlink and access downlink is activated in a specific time). Similarly, the backhaul uplink and access uplink may be multiplexed on one carrier frequency according to the TDM scheme (i.e., only one of the backhaul uplink and access uplink is activated in a specific time).

In the backhaul link multiplexing in FDD, backhaul downlink transmission may be performed in a downlink frequency band, and backhaul uplink transmission may be performed in an uplink frequency band. In the backhaul link multiplexing in TDD, backhaul downlink transmission may be performed in a downlink subframe of an eNB and a relay node, and backhaul uplink transmission may be performed in an uplink subframe of an eNB and a relay node.

In the case of an in-band relay node, for example, if backhaul downlink reception from an eNB and access downlink transmission to a UE are performed in the same frequency band at the same time, signal interference may be generated from the reception stage of the relay node due to a signal transmitted by the transmission stage of the relay node. That is, signal interference or RF jamming may be generated from the RF front end of the relay node. Likewise, if backhaul uplink transmission to an eNB and access uplink reception from a UE are performed in the same frequency band at the same time, signal interference may be generated.

Accordingly, in order for a relay node to transmit/receive signals in the same frequency band at the same time, it is difficult to implement the simultaneous transmission if sufficient separation between a reception signal and a transmission signal (e.g., a transmit antenna and a receive antenna are sufficiently isolated geographically, such as that the transmit antenna and the receive antenna are installed on the ground/underground).

One scheme for solving such a signal interference problem is that a relay node operates to not send a signal to a UE while it receives a signal from a donor cell. That is, a gap is generated in transmission from the relay node to the UE. During the gap, the UE (including a legacy UE) may be configured to not expect any transmission from the relay node. Such a gap may be configured by configuring a multicast broadcast single frequency network (MBSFN) subframe.

FIG. 18 illustrates a structure of relay resource partitioning in the wireless communication system to which the present invention can be applied.

In FIG. 18, in the case of a first subframe as a general subframe, a downlink (that is, access downlink) control signal and downlink data are transmitted from the relay node and in the case of a second subframe as the MBSFN subframe, the control signal is transmitted from the relay node from the terminal in the control region of the downlink subframe, but no transmission is performed from the relay node to the terminal in residual regions. Herein, since the legacy terminal expects transmission of the PDCCH in all downlink subframes (in other words, since the relay node needs to support legacy terminals in a region thereof to perform a measurement function by receiving the PDCCH every subframe), the PDCCH needs to be transmitted in all downlink subframes for a correct operation of the legacy terminal. Therefore, eve on a subframe (second subframe) configured for downlink (that is, backhaul downlink) transmission from the base station to the relay node, the relay does not receive the backhaul downlink but needs to perform the access downlink transmission in first N (N=1, 2, or 3) OFDM symbol intervals of the subframe. In this regard, since the PDCCH is transmitted from the relay node to the terminal in the control region of the second subframe, the backward compatibility to the legacy terminal, which is served by the relay node may be provided. In residual regions of the second subframe, the relay node may receive transmission from the base station while no transmission is performed from the relay node to the terminal. Therefore, through the resource partitioning scheme, the access downlink transmission and the backhaul downlink reception may not be simultaneously performed in the in-band relay node.

The second subframe using the MBSFN subframe will be described in detail. The control region of the second subframe may be referred to as a relay non-hearing interval. The relay non-hearing interval means an interval in which the relay node does not receive the backhaul downlink signal and transmits the access downlink signal. The interval may be configured by the OFDM length of 1, 2, or 3 as described above. In the relay node non-hearing interval, the relay node may perform the access downlink transmission to the terminal and in the residual regions, the relay node may receive the backhaul downlink from the base station. In this case, since the relay node may not simultaneously perform transmission and reception in the same frequency band, It takes a time for the relay node to switch from a transmission mode to a reception mode. Therefore, in a first partial interval of a backhaul downlink receiving region, a guard time (GT) needs to be set so that the relay node switches to the transmission/reception mode. Similarly, even when the relay node operates to receive the backhaul downlink from the base station and transmit the access downlink to the terminal, the guard time for the reception/transmission mode switching of the relay node may be set. The length of the guard time may be given as a value of the time domain and for example, given as a value of k (k≥1) time samples (Ts) or set to the length of one or more OFDM symbols. Alternatively, when the relay node backhaul downlink subframes are consecutively configured or according to a predetermines subframe timing alignment relationship, a guard time of a last part of the subframe may not be defined or set. The guard time may be defined only in the frequency domain configured for the backhaul downlink subframe transmission in order to maintain the backward compatibility (when the guard time is set in the access downlink interval, the legacy terminal may not be supported). In the backhaul downlink reception interval other than the guard time, the relay node may receive the PDCCH and the PDSCH from the base station. This may be expressed as a relay (R)-PDCCH and a relay-PDSCH (R-PDSCH) in a meaning of a relay node dedicated physical channel.

Quasi Co-Located (QCL) Between Antenna Ports

Quasi co-located or quasi co-location (QC/QCL) may be defined as follows.

If two antenna ports are in a QC/QCL relation (or subjected to QC/QCL), a UE may assume that the large-scale property of a signal delivered through one antenna port may be inferred from a signal delivered through another antenna port. In this case, the large-scale property include one or more of delay spread, Doppler spread, a frequency shift, average received power and received timing.

Furthermore, the large-scale property may be defined as follows. If two antenna ports are in a QC/QCL relation (or subjected to QC/QCL), a UE may assume that the large-scale property of a channel through which one symbol is delivered through one antenna port may be inferred from a radio channel through which one symbol is delivered through another antenna port. In this case, the large-scale property include one or more of delay spread, Doppler spread, Doppler shift, an average gain and average delay.

That is, if two antenna ports are in a QC/QCL relation (or subjected to QC/QCL), this means that the large-scale property of a radio channel from one antenna port is the same as the large-scale property of a radio channel from the remaining one antenna port. If a plurality of antenna ports in which an RS is transmitted is taken into consideration, when antenna ports in which different two types of RSs are transmitted have a QCL relation, the large-scale property of a radio channel from one antenna port may be substituted with the large-scale property of a radio channel from the other antenna port.

In this specification, the above QC/QCL-related definitions are not distinguished. That is, the QC/QCL concept may comply with one of the definitions. Or, in a similar form, the QC/QCL concept definition may be modified into a form in which transmission may be assumed between antenna ports having a QC/QCL assumption as if it is performed in the co-location (e.g., a UE may assume antenna ports transmitted at the same transmission point). The spirit of the present invention includes such similar modified examples. In the present invention, for convenience of description, the above QC/QCL-related definitions are interchangeably used.

According to the QC/QCL concept, a UE cannot assume the same large-scale property between radio channels from corresponding antenna ports with respect to non-QC/QCL antenna ports. That is, in this case, the UE must perform independent processing on each non-QC/QCL antenna port configured with respect to timing acquisition and tracking, frequency offset estimation and compensation, delay estimation and Doppler estimation.

There is an advantage in that a UE can perform the following operation between antenna ports capable of assuming QC/QCL:
With respect to delay spread and Doppler spread, the UE may apply a power-delay profile, delay spread, a Doppler spectrum, Doppler spread estimation results for a radio channel from any one antenna port to a Wiener filter used upon channel estimation for a radio channel from another antenna port in the same manner.
With respect to frequency shift and received timing, the UE may apply the same synchronization to the demodulation of another antenna port after performing time and frequency synchronization on any one antenna port.
With respect to average received power, the UE may average reference signal received power (RSRP) measurement for two or more antenna ports.

For example, if DMRS antenna ports for downlink data channel demodulation have been subjected to QC/QCL with the CRS antenna port of a serving cell, the UE can improve DMRS-based downlink data channel reception performance by likewise applying the large-scale property of a radio channel estimated from its own CRS antenna port upon channel estimation through a corresponding DMRS antenna port.

The reason for this is that an estimate regarding the large-scale property can be more stably obtained from a CRS because the CRS is a reference signal broadcasted with relatively high density every subframe and over a full band. In contrast, a DMRS is transmitted in a UE-specific manner with respect to a specific scheduled RB. Furthermore, the precoding matrix of a precoding resource block group (PRG) unit used by an eNB for transmission may be changed, and thus a valid channel received by a UE may vary in a PRG unit. Although a plurality of PRGs has been scheduled, performance deterioration may occur if the DMRS is used to estimate the large-scale property of a radio channel in a wide band. Furthermore, since a CSI-RS may have a transmission period of several˜several tens of ms and a resource block has low density of 1 resource element per antenna port on average, performance deterioration may occur if the CSI-RS is used to estimate the large-scale property of a radio channel.

That is, a UE can use it for the detection/reception of a downlink reference signal, channel estimation and a channel state report by QC/QCL assumption between antenna ports.

Device-to-Device (D2D) Communication

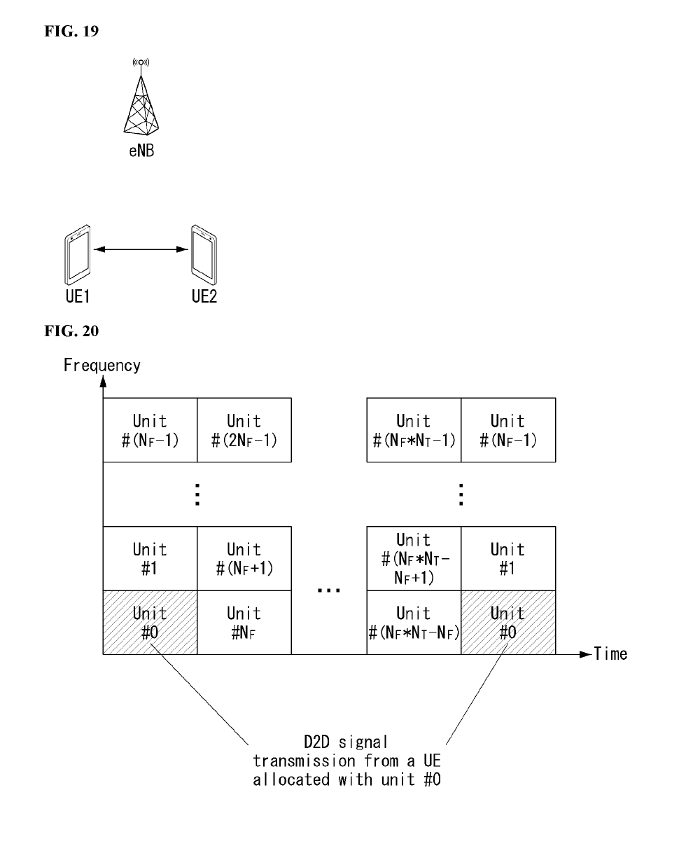

FIG. 19 is a diagram for illustrating the elements of a direct communication (D2D) scheme between UEs.

In FIG. 19, a UE means the UE of a user, and corresponding network equipment may also be taken into consideration to be a kind of UE if the network equipment, such as an eNB, transmits/receives a signal according to a communication method with the UE. Hereinafter, a UE1 may operate to select a resource unit corresponding to specific resources within a resource pool that means a set of a series of resources and to transmit a D2D signal using the corresponding resource unit. A UE2, that is, a reception UE for the UE1, receives a configuration for the resource pool in which the UE1 may send a signal, and detects the signal of the UE1 within the corresponding pool. In this case, an eNB may notify the UE 1 of the resource pool if the UE 1 is located within the connection range of the eNB. If the UE 1 is out of the connection range of the eNB, another UE may notify the UE 1 of the resource pool or the resource pool may be previously determined to be predetermined resources. In general, the resource pool may include a plurality of resource units, and each UE may select one or a plurality of resource units and use it for its own D2D signal transmission.

FIG. 20 is a diagram showing an embodiment of the configuration of a resource unit.

Referring to FIG. 20, all of frequency resources have been partitioned into N_F, all of time resources have been partitioned into N_T, and thus a total of N_F*N_T resource units may be defined. In this case, it may be expressed that a corresponding resource pool is repeated using an N_T subframe as a cycle. Characteristically, as shown in this drawing, one resource unit may periodically repeatedly appear. Or in order to obtain a diversity in a time or frequency dimension, the index of a physical resource unit to which one logical resource unit is mapped may change in a predetermined pattern over time. In such a resource unit structure, the resource pool may mean a set of resource units that a UE trying to send a D2D signal may use for transmission.

The aforementioned resource pool may be subdivided into several types. First, the resource pool may be divided depending on the contents of a D2D signal transmitted in each resource pool. For example, the contents of a D2D signal may be divided as follows, and a separate resource pool may be configured in each of the contents.

Scheduling assignment (SA): a signal including the location of resources used as the transmission of a D2D data channel used by each transmission UE, a modulation and coding scheme (MCS) necessary for the demodulation of other data channels or information, such as an MIMO transmission method and/or timing advance. The signal may be multiplexed with D2D data on the same resource unit and transmitted. In this specification, an SA resource pool may mean a pool of resources in which SA is multiplexed with D2D data and transmitted, and may also be called a D2D control channel.

A D2D data channel: a resource pool used for a transmission UE to send user data using resources designated through SA. If the resource pool may be multiplexed with D2D data on the same resource unit and transmitted, only a D2D data channel of a form other than SA information may be transmitted in a resource pool for a D2D data channel. In other words, a resource element used to transmit SA information on an individual resource unit within an SA resource pool may still be used to send D2D data in a D2D data channel resource pool.

A discovery channel: a resource pool for a message that enables a transmission UE transmits information, such as its own ID, so that an adjacent UE can discover the transmission UE.

In contrast, if the contents of a D2D signal are the same, a different resource pool may be used depending on the transmission/reception attributes of the D2D signal. For example, even in the case of the same D2D data channel or discovery message, it may be classified as a different resource pool depending on a transmission timing determination method of a D2D signal (e.g., whether the D2D signal is transmitted in the reception occasion of a synchronization reference signal or it is transmitted by applying a specific timing advance in a corresponding occasion) or a resource allocation method (e.g., whether an eNB designates the transmission resources of an individual signal for an individual transmission UE or an individual transmission UE autonomously selects individual signal transmission resources within each pool), a signal format (e.g., the number of symbols that each D2D signal occupies within one subframe or the number of subframes used for the transmission of one D2D signal), signal intensity from an eNB, and transmit power intensity of a D2D UE.

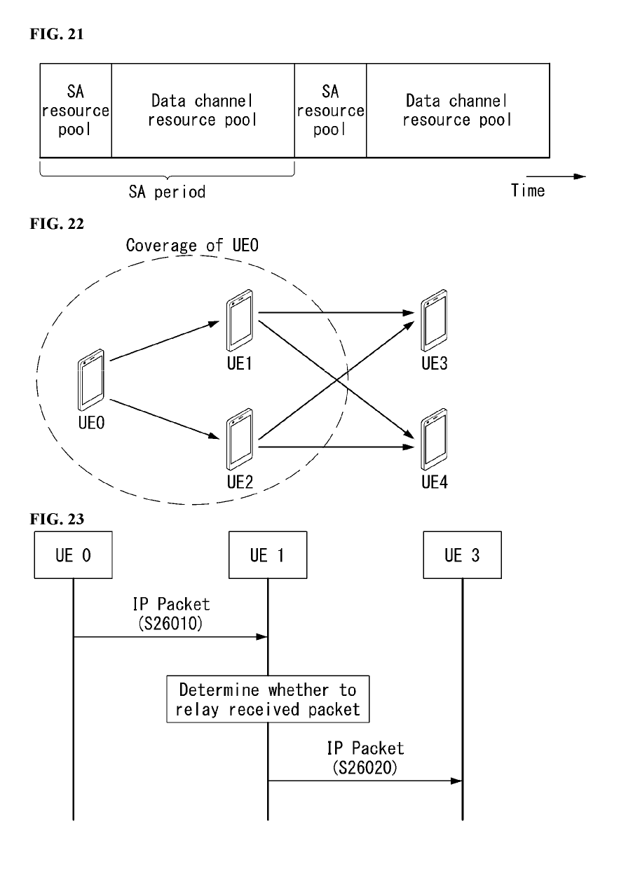

FIG. 21 shows a case where an SA resource pool and a following data channel resource pool periodically appear. Hereinafter, the period in which an SA resource pool appears is called an SA period.

The present invention provides a method of selecting resources for transmitting a relay signal when a relay operation is performed in D2D communication.

In this specification, for convenience of description, a method for an eNB to directly indicate the transmission resources of a D2D transmission UE in D2D communication is called/defined as Mode 1, and a method in which a transmission resource region has been previously configured or a method for an eNB to designate a transmission resource region and for a UE to directly select transmission resources is called/defined as Mode 2. In the case of D2D discovery, a case where an eNB directly indicates resources is called/defined as Type 2, and a case where a UE directly selects transmission resources in a previously configured resource region or in a resource region indicated by an eNB is called/defined as Type 1.

The aforementioned D2D may also be called a sidelink. SA may be called a physical sidelink control channel (PSCCH), and a D2D synchronization signal is called a sidelink synchronization signal (SSS), and a control channel through which the most basic information is transmitted prior to [symbol] D2D communication transmitted along with the SSS may be called a physical sidelink broadcast channel (PSBCH) or a physical D2D synchronization channel (PD2DSCH) as another name. A signal used for a specific UE to provide notification that it is located nearby, in this case, the signal may include the ID of the specific UE. Such a channel may be called a physical sidelink discovery channel (PSDCH).

In D2D of Rel. 12, only a D2D communication UE has transmitted a PSBCH along with an SSS. Accordingly, the measurement of an SSS is performed using the DMRS of a PSBCH. An out-coverage UE measures the DMRS of a PSBCH, measures the reference signal received power (RSRP) of the signal, and determines whether it will become its synchronization source.

FIGS. 22 to 24 are diagrams illustrating an example of a relay process and a resource for relay according to an exemplary embodiment of the present invention.

Referring to FIGS. 22 to 24, in a communication system that supports device-to-device communication, by transmitting data to a terminal outside coverage through relay, the terminal may substantially extend coverage.

Specifically, as shown in FIG. 22, a UE 1 and/or a UE 2, which are UEs within coverage of a UE 0 may receive a message transmitted by the UE 0.

However, the UE 0 cannot directly transmit a message to a UE 3 and a UE 4 existing outside coverage. Therefore, in such a case, in order to transmit a message to the UE 3 and the UE 4 outside coverage of the UE 0, the UE 0 may perform a relay operation.

In order to transmit a message to the terminal existing outside coverage, the relay operation means an operation in which terminals within coverage transfer a message.

FIG. 23 illustrates an example of the relay operation, and when the UE 0 transmits a data packet to the UE 3 outside coverage, the UE 0 may transmit the data packet to the UE 3 through the UE 1.

Specifically, when the UE 0 transmits the data packet to the UE 3, the UE 0 sets a parameter representing whether the data packet may be relayed to execution of a relay operation and transmits the data packet (S26010).

The UE 1 receives the data packet and determines whether to relay the data packet is through the parameter.

When the parameter instructs a relay operation, the UE 1 transmits the received data packet to the UE 3, and when the parameter does not instruct a relay operation, the UE 1 does not transmit the data packet to the UE 3.

The UE 0 may transmit a message to the terminal existing outside coverage through such a method.

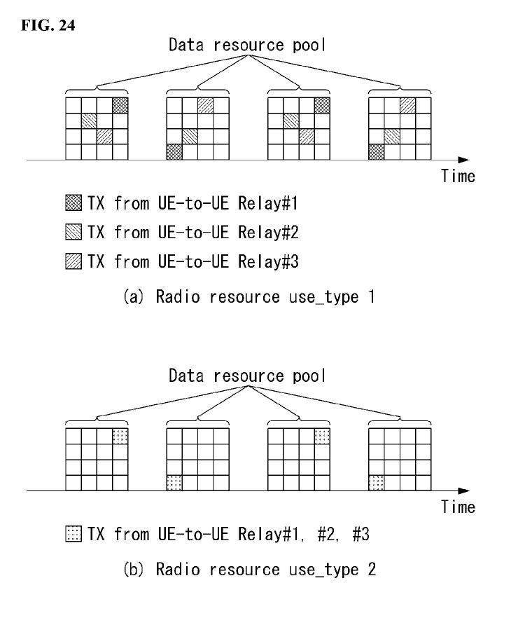

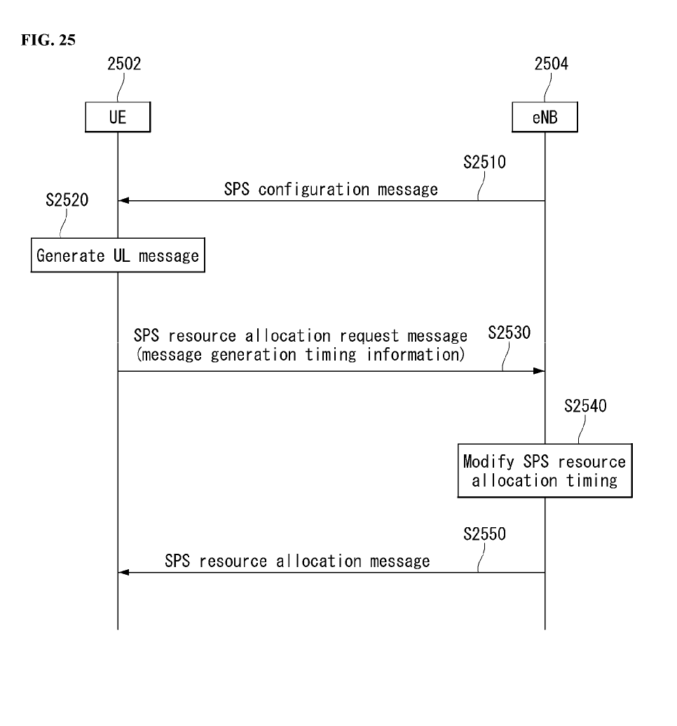

FIG. 24 illustrates an example of a method of selecting a resource for a relay operation.

Referring to FIG. 24(a), the terminal may autonomously select a resource in a resource pool to relay a message. That is, UEs (UE 1, UE 2, and UE 3) that relay the same message may randomly select a resource in a resource pool to relay the same message.

However, in such a case, there is a problem that a receiving terminal that receives a message repeatedly receives the same message through different resources.

Therefore, as shown in FIG. 24(b), in a resource pool, a resource for relay is allocated, and when each relay terminal transmits a message through an allocated resource, the receiving terminal may receive the same message through the same resource, thereby reducing resource waste.

Radio Resource Scheduling Method

The present invention proposes a method for scheduling a radio resource for a UE in a wireless communication system.

In particular, in the present invention, a wireless communication environment in which vehicle-to-everything (V2X) is performed using a radio channel is taken into consideration. V2X includes communication between a vehicle and all of entities, such as vehicle-to-vehicle (V2V) denoting communication between vehicles, vehicle to infrastructure (V2I) denoting communication between a vehicle and an eNB or a road side unit (RSU), and vehicle-to-pedestrian (V2P) denoting communication between a vehicle and a UE held by a person (a pedestrian, bicycle driver, vehicle driver or passenger).

Hereinafter, in the description of the present invention, a UE may include not only a common UE, but also a UE (i.e., vehicle) performing V2X (vehicle UE (V-UE)).

In a common wireless communication environment and/or a wireless communication environment in which V2X is performed, a UE may perform semi-persistent scheduling (SPS) along with a base station (eNodeB, eNB).

In particular, the UE and the eNB may use SPS for the signaling of a safety message. For example, the UE may transmit a collision prevention message, including location information of the UE and mobility information (e.g., velocity) of the UE, to the eNB using an SPS method.

If the eNB transmits data (e.g., downlink data) to the UE using the SPS method, the eNB may configure transmission timing for data through optimized scheduling.

In contrast, if the UE transmits data (e.g., uplink data) to the eNB using the SPS method, the eNB is unaware of information about the generation of the uplink data and/or the arrival of the uplink data (e.g., a message generated by an upper stage reaches a lower stage).

Accordingly, there may be a great difference between the timing when data to be transmitted from the UE to the eNB was generated (or the generation timing of the data) and the timing when the UE actually transmits the data after the UE is allocated with a resource from the eNB (or after resource scheduling by the eNB).

In other words, latency (or delay) may occur until data is actually transmitted after the data to be transmitted from the UE to the eNB is generated.

In this case, if a latency value increases and thus a given (or specific) requirement condition is not satisfied, a message loss (e.g., message drop may occur.

Accordingly, in the case of a message that requires urgency (e.g., V2X safety message), it is important to prevent a message loss attributable to latency, such as that described above.

Accordingly, in a wireless communication environment supporting (or performing) V2X, there is proposed a method of aligning timing between the generation (or occurrence) timing of uplink data and the timing when the data is actually transmitted (or method of reducing latency between the generation timing and the transmission timing).

In the following description, a message may mean a message used by a UE to transmit uplink data to an eNB.

Method of Reporting Generation Timing of Message

As described above, an eNB is accurately unaware of the message generation timing of a UE (e.g., the timing when a message was generated by an application layer or the timing when a message was generated by an upper stage and reached a lower stage (e.g., physical layer)).

Accordingly, in an embodiment of the present invention, a UE may (directly) report information about the generation timing of a message and/or the generation period of the message to an eNB.

FIG. 25 shows a method of requesting SPS resource allocation according to an embodiment of the present invention. FIG. 25 is for convenience of description only, and does not limit the scope of the present invention.

Referring to FIG. 25, it is assumed that each of a UE 2502 and an eNB 2504 supports an SPS operation and the eNB 2504 supports the UE 2502.

In step S2510, the eNB 2504 may transmit an SPS configuration message including SPS resource allocation information to the UE 2502.

In this case, the SPS configuration message may include allocation timing (or period) information of an SPS resource (i.e., uplink (UL) resource or downlink (DL) resource) allocated to the UE 2502, time/frequency domain location information of an eNB 2504 resource unit, the number of HARQ processes and/or number information for determining whether an SPS resource has been released.

After the UE 2502 receives the SPS configuration message from the eNB 2504, the UE 2502 may generate an uplink message (or UL data) in step S2520. In this case, the uplink message may mean a message to be transmitted from the UE 2502 to the eNB 2504 using (or through) SPS. Furthermore, the uplink message may mean a message generated using an upper stage (e.g., application layer) or a lower stage (e.g., PHY layer).

After the UE 2502 generates the uplink message, the UE 2502 may transmit an SPS resource allocation request message, including (or carrying) information about the generation timing of the message, to the eNB 2504 in step S2530.

For example, the UE 2502 may transmit the information about the generation timing (e.g., system frame number (SFN) and subframe offset) of the message and/or the generation period (e.g., 100 ms) of the message to the eNB 2504 by mapping (or encoding) the information to a PUSCH channel (e.g., IRB).

In this case, the PUSCH channel used for the transmission may be any one of predetermined resource(s) having a given size within a given area of a subframe or may be a resource directly allocated to the UE 2502 through a scheduling request (SR), a random access process (e.g., physical random access channel (PRACH), etc.

More specifically, if the UE 2502 is allocated with a buffer status report (BSR) from the eNB 2504 through an SR method, the UE may report message generation timing using the allocated BSR. In this case, the UE 2502 may map the timing when the message was generated (e.g., timing when a MAC protocol data unit (PDU) was generated by a medium access control (MAC) layer or timing when the message was generated by a layer higher than the MAC layer) to some area (e.g., message generation timing field) of the allocated BSR.

After the eNB 2504 receives the SPS resource allocation request message (message including the information about the generation timing of the message and/or the generation period of the message) from the UE 2502, the eNB 2504 may modify SPS resource allocation timing (or period) for the UE 2502 using the received information in step S2540.

In other words, the eNB 2504 may (re)designate the SPS timing (or SPS transmission timing) and/or an SPS resource allocation period (e.g., SPS uplink (UL) grant period) of the UE 2502.

After the eNB 2504 modifies the SPS resource allocation timing for the UE 2502, the eNB 2504 may transmit an SPS resource allocation message (SPS UL grant or SPS activation message) to the UE 2502 according to the modified SPS resource allocation timing in step S2550.

For example, the eNB 2504 may transmit an UL grant for SPS to the UE 2502 with a given offset from the timing when a report on the generation timing of the message was received from the UE 2502. In this case, the offset may have a value that is not negative.

More specifically, assuming that the timing when the eNB 2504 receives a report from the UE 2502 is an n-th subframe, the eNB 2504 may transmit an SPS UL grant to the UE 2502 in an (n+4)-th subframe. In this case, the UL grant may be an SPS activation (or resource allocation) message.

In this case, in order to safely receive the UL grant transmitted by the eNB 2504, the UE 2502 may monitor the UL grant in all of subframes in addition to a specific subframe (e.g., a fourth subframe after a subframe in which the message was generated).

Furthermore, in various embodiments of the present invention, if an eNB receives (receives a report on) information about message generation timing from multiple UEs, the eNB may perform scheduling so that resources for the UEs are prevented from being concentrated and allocated at specific timing.

In other words, if an eNB receives information about the generation timing of a message from multiple UEs in an n-th subframe, the eNB may transmit SPS UL grants to the multiple UEs at different timings not the same timing (or subframe).

For example, if a first UE and a second UE are included in the multiple UEs, the eNB may transmit a first SPS UL grant to the first UE in an (n+a0)-th subframe and transmit a second SPS UL grant to the second UE in an (n+a1)-th subframe.

Accordingly, the eNB can efficiently manage (e.g., load balancing) a load attributable to the UEs.

Furthermore, in this case, after corresponding UEs report the generation timing of messages, they may monitor SPS UL grants in all of subframes.

Furthermore, in various embodiments of the present invention, for a smooth SPS operation upon handover (or cell reselection), an eNB (or serving eNB) may transmit information about the generation timing of a message and/or the generation period of the message related to a UE(s) performing handover to an eNB of a neighbor cell.

Method of Reporting Generation Timing of Message Using SR if SPS has been Configured

As a detailed example of the method for a UE to request SPS resource allocation by reporting the generation timing of a message, the UE may make a scheduling request (SR) for the SPS resource by immediately performing the SR at the timing when uplink data is reached.

In the following description part for the method of reporting the generation timing of a message using an SR, a UE may be the UE 2502 of FIG. 25, and an eNB may be the eNB 2504 of FIG. 25.

If a UE reports the generation timing of a message using an SR, the SPS resource allocation request message transmitted in S2530 of FIG. 25 may be substituted with an SR message.

In this case, if a PUCCH resource (suitable) (or may be used for transmission) for a specific UE to transmit the SR has not been allocated (or occurred), the UE may transmit the SR after the suitable PUCCU resource is allocated.

If a UE reports the generation timing of a message to an eNB using SR transmission, the state in which SPS between the eNB and the UE has been configured (and/or the state in which an SPS operation has been activated) is assumed. In this case, the timing when uplink data is reached may mean the timing when the uplink data arrives at a lower stage (e.g., PHY layer) or the timing when a message to be transmitted from a lower stage to the eNB is generated.

That is, the eNB can be aware of the location of an SR closest to the message generation timing of the UE (or location where the UE wants to transmit the SR) through the SR transmitted by the UE. Accordingly, the eNB can be implicitly aware of the generation timing of a message to be transmitted by the UE.

Latency upon data transmission in the method may be the same as latency of the (existing) SR method.

In this case, a difference between the method and the (existing) SR method is that resource allocation after SR transmission complies with an SPS resource allocation method. Accordingly, if SPS has been configured, in a method of reporting the generation timing of a message using an SR, a UE does not need to perform additional SR transmission until an SPS resource is released (or deactivated).

In order to perform the aforementioned operation, in the state in which SPS has been configured, if a UE requests SPS scheduling using SR transmission (or if an SR operation and an SPS operation overlap), only an SPS resource allocation offset between an eNB and the UE may be defined in advance (or previously) to be adjusted (or controlled) to be suitable for the (existing) SR method and actual resource allocation may be defined in advance (or previously) to be allocated according to the SPS method.

Furthermore, in various embodiments of the present invention, in the state in which SPS has been configured, if a UE requests SPS scheduling using SR transmission, an eNB may recognize that the SR transmission reports message generation timing. To this end, information about the method may have been previously defined between the eNB and the UE, or a message type field indicating that an SR transmitted by the UE is for reporting the generation timing of an uplink message may be used.

Furthermore, in various embodiments of the present invention, if an eNB receives an SR for an SPS scheduling request from a UE, the eNB may reconfigure the transmission timing of an SPS UL grant.

For example, the eNB may transmit an additional (or not configured in the past) SPS UL grant to the UE after an SR is transmitted by the UE (or received from the UE). In this case, the eNB may transmit the existing configured SPS UL grant according to a set period (or timing).

For another example, an eNB may transmit a previously configured (or scheduled to be transmitted next) SPS UL grant to a UE after an SR is transmitted by the UE (or received from the UE). In this case, the transmission timing of all of subsequent SPS UL grants may be advanced (or become faster) by the SR transmission. To this end, the SPS UL grant transmitted to the UE based on the SR may include information (e.g., offset) about the transmission timing of a subsequent SPS UL grant. Alternatively, the UE may be implicitly aware of an offset value using the transmission timing of a previously received SPS UL grant.

Method of Requesting Transmission Timing of UL Data

In the aforementioned method, a UE (explicitly or implicitly) reports the transmission timing of a message (e.g., message generation timing offset), and an eNB has allocated an SPS resource by incorporating the transmission timing.

However, if an eNB schedules SPS (or allocate an SPS resource) in the situation in which the traffic of UL data is much, latency may occur because overhead for allocating a resource in which SPS will be actually transmitted by the eNB is increased.

Accordingly, in another embodiment of the present invention, a UE may directly request the allocation of a resource from an eNB at its preferred (or requested) UL data transmission timing.

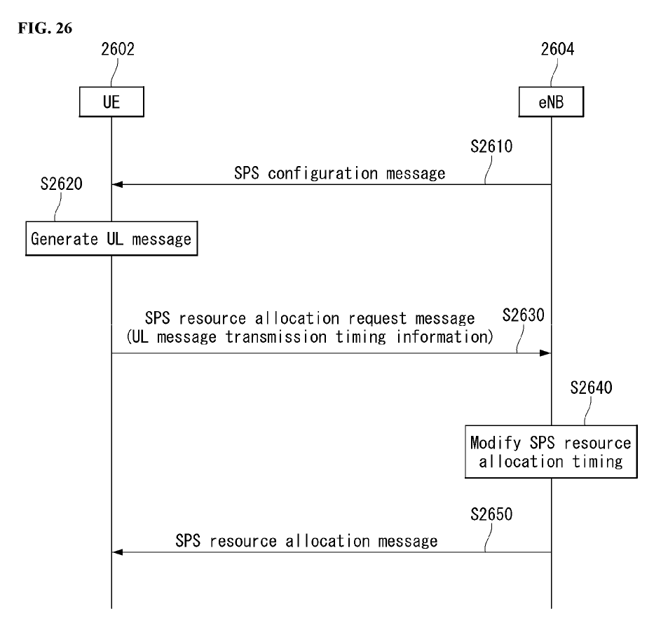

FIG. 26 shows a method of requesting SPS resource allocation according to another embodiment of the present invention. FIG. 26 is for convenience of description only and does not limit the scope of the present invention.

Referring to FIG. 26, it is assumed that each of a UE 2602 and an eNB 2604 supports an SPS operation and the eNB 2604 supports the UE 2602.

In step S2610, the eNB 2604 may transmit an SPS configuration message including SPS resource allocation information to the UE 2602.

In this case, the SPS configuration message may include allocation timing (or period) information of an SPS resource (i.e., uplink (UL) resource or downlink (DL) resource) allocated to the UE 2602, time/frequency domain location information of an eNB 2604 resource unit, the number of HARQ processes and/or number information for determining whether an SPS resource will be released.

After the UE 2602 receives the SPS configuration message from the eNB 2604, the UE 2602 may generate an uplink message (or UL data) in step S2620. The operation of the UE in step S2620 is similar to the operation of the UE in step S2520 of FIG. 25, and thus a detailed operation thereof is omitted.

After the UE 2602 generates the uplink message, the UE 2602 may transmit an SPS resource allocation request message, including (or carrying) information about the timing when the message will be transmitted, to the eNB 2604 in step S2630.

For example, the UE 2602 may directly indicate specific timing (e.g., a specific subframe of a specific SFN) when UL data will be transmitted using an SPS method. In other words, the UE 2602 may transmit a request message (e.g., SPS resource allocation request message) indicating specific timing when UL data will be transmitted using SPS to the eNB 2604.

For another example, the UE may indicate (or denote) a given range of timing when UL data will be transmitted using SPS. In other words, the UE may transmit a request message (e.g., SPS resource allocation request message)) indicating a given range of timing when UL data will be transmitted using SPS to the eNB.

More specifically, the UE may designate the upper value and lower bound of timing for SPS resource allocation by taking into consideration (or considering) latency of a message to be transmitted to the eNB. For example, if a UE wants SPS transmission in the fourth to sixth subframe of a specific radio frame, the UE may transmit a resource allocation request message indicating the fourth subframe of the specific radio frame as an upper value and/or indicating the sixth subframe of the specific radio frame as a lower bound to the eNB.

If the UE wants SPS transmission in the fifth subframe, the UE may transmit a resource allocation request message indicating the fourth subframe of the specific radio frame and/or the sixth subframe of the specific radio frame to the eNB.

In this case, the aforementioned upper value and lower bound may be indicated in the form of a system frame number (SFN) and a subframe number.

After the eNB 2604 receives the SPS resource allocation request message from the UE 2602, the eNB 2604 may modify SPS resource allocation timing (or period) for the UE 2602 based on information included in the received request message in step S2640.

For example, if the eNB 2604 receives information (or request message) about specific timing when UL data will be transmitted from the UE 2602 and accepts the request (or specific timing) of the UE 2602, SPS resource allocation may be periodically repeated based on the specific timing.

In other words, the SPS resource allocation by the eNB 2604 may be repeated based on an SPS period configured with respect to the UE 2602.

In this case, the UE 2602 may be allocated with a resource for SPS transmission at timing shown in Equation 6 below.

(10*SFN+subframe)=[(10*SFNrequest+subframerequest)+N*semiPersistSchedIntervalUL] modulo 10240 [Equation 6]

In Equation 6, “SFNrequest” may mean the frame number (SFN) of timing (or timing when SPS wants to be allocated) when resource allocation for SPS transmission is requested. “subframerequest” may mean the subframe number of timing when resource allocation for SPS transmission is requested. “semiPersistSchedIntervalUL” may mean the interval of uplink SPS, and “N” may mean the number or order of SPS resource allocation.

For another example, if the eNB 2604 receives information (upper value and/or lower bound) about a given (or specific) range in which UL data will be transmitted from the UE 2602, the eNB 2604 may determine an area to which an SPS resource will be allocated using the information.

In this case, if a lower bound for UL data transmission has not been specially designated (or if the UE 2602 transmits a request message including only an information field for the upper value of SPS resource allocation timing to the eNB 2604), the eNB 2604 may recognize the timing (or timing when the request message is transmitted) requested by the UE 2602 as a lower bound.

Accordingly, the eNB 2604 may allocate an SPS resource (e.g., allocate an SPS UL grant) at the earliest timing after the request of the UE 2602 is received.

After the eNB 2604 modifies the SPS resource allocation timing for the UE 2602, the eNB 2604 may transmit an SPS resource allocation message (SPS UL grant or SPS activation message) to the UE 2602 based on the modified SPS resource allocation timing in step S2650.

Delay Margin for SPS Resource Request

The aforementioned methods (or schemes) (or methods described in FIGS. 25 and 26) are methods for minimizing a difference between message generation timing in a UE and UL SPS transmission timing (or timing when a message is actually transmitted).

The methods are performed because accurate timing of an SPS UL grant transmitted by an eNB is unaware. However, assuming that an SPS UL grant may be received faster than as expected, a UE may wait until an SPS UL grant is received (without requesting SPS resource allocation).

Accordingly, in various embodiments of the present invention, the concept of a delay margin may be used in order for a UE to calculate a maximum time during which the UE may monitor an SPS UL grant without requesting SPS resource allocation.

Latency basically occurring at timing when a message is generated at a lower stage (e.g., physical (PHY) layer) of a UE may be expressed as T_{msg}. For example, T_{msg} may be latency taken for a message to be delivered from the application layer to the PHY layer or latency according to an RRC configuration.

Furthermore, latency that may additionally occur until a corresponding message (or message for an SPS UL grant) is finally transmitted to a UE(s) may be expressed as T_{UE}. For example, if an eNB receives an uplink message and transmits the message to a UE(s) in downlink, latency in downlink may occur.

Furthermore, latency that may occur when an SPS resource is requested using a specific method (e.g., method of reporting the generation timing of a message using an SR) may be expressed as T_{SPS}.

Furthermore, a delay margin in preparation for a case where additional delay (latency) may occur may be expressed as Tₐ.

If the time that may be delayed in terms of an SPS configuration (e.g., latency requirement) is expressed as Tₗₐₜ (e.g., 100 ms) based on the aforementioned values, a maximum time (T_{max-monitoring}) during which a UE may monitor an SPS UL grant is shown in Equation 7 below.

T_{max-monitoring}=Tₗₐₜ−(T_{msg}+T_{UE}+T_{SPS}+Tₐ) [Equation 7]

In other words, after an uplink message to be transmitted to an eNB is generated, a UE may drive a timer corresponding to T_{max-monitoring}.

Accordingly, the UE simply monitors an SPS UL grant until the timer expires.

In contrast, if an SPS UL grant is not received until the timer expires, the UE may request the allocation of an SPS resource from the eNB. In this case, the UE may request the allocation of the SPS resource (or SPS UL grant) using the aforementioned specific methods (e.g., method of reporting the message generation timing of the UE or method of requesting a resource at the time when the UE will transmit UL data).

In various embodiments of the present invention, the aforementioned specific methods (e.g., method of reporting the message generation timing of a UE or method of requesting a resource at the time when a UE will transmit UL data) may be optimized using the timer.

For example, after a UE (e.g., UE 2502 or UE 2602) monitors (or observes) an SPS UL grant using the timer during a maximum time as long as possible, the UE transmits a request message (or report message) for SPS resource allocation to the eNB. Accordingly, an unnecessary operation of the UE, such as that the UE transmits a request message to the eNB although it is the time during which the UE monitors an SPS UL grant.

In this case, the timer may perform a role of a trigger for the specific methods.

Method of Requesting Change of SPS Resource Allocation Offset

In general, the surest method capable of being aware of a difference between message generation timing (e.g., periodically generated message) and SPS resource allocation timing in a UE is to wait until a message (SPS UL grant) for the first SPS resource allocation is received.

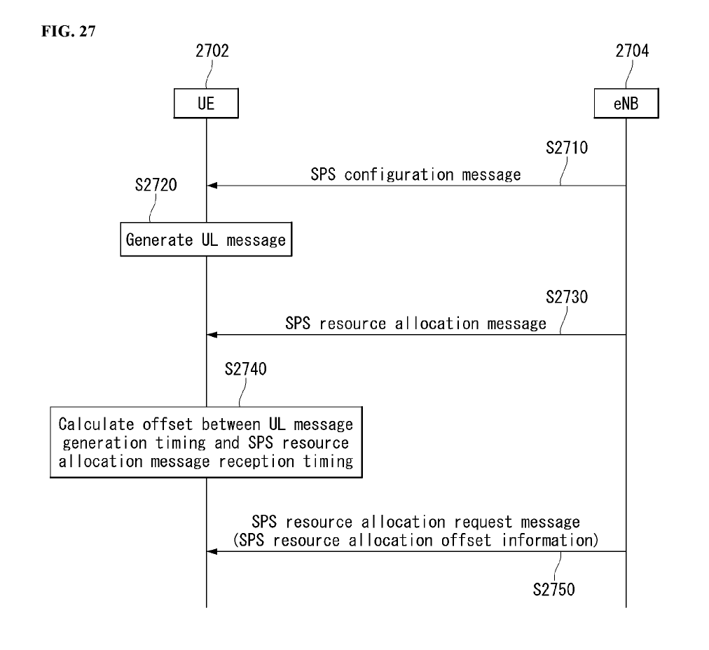

FIG. 27 shows a method of requesting SPS resource allocation according to yet another embodiment of the present invention. FIG. 27 is for convenience of description only and does not limit the scope of the present invention.

Referring to FIG. 27, it is assumed that each of a UE 2702 and an eNB 2704 supports an SPS operation and the eNB 2704 supports the UE 2702.

In step S2710, the eNB 2704 may transmit an SPS configuration message including SPS resource allocation information to the UE 2702.

In this case, the SPS configuration message may include allocation timing (or period) information of an SPS resource (i.e., uplink (UL) resource or downlink (DL) resource) allocated to the UE 2702.

After the UE 2702 receives the SPS configuration message from the eNB 2704, the UE 2702 may generate an uplink message (or UL data) in step S2720. The operation of the UE in step S2720 is similar to the operation of the UE in step S2520 of FIG. 25 and step S2620 of FIG. 26, and thus a detailed operation thereof is omitted.

After the UE 2702 generates the uplink message, the UE 2702 may receive an SPS resource allocation message (SPS UL grant or SPS activation message) from the eNB 2704 in step S2730.

In this case, the eNB 2704 may allocate a resource in which the UE 2702 may actually transmit UL data to the UE 2702 through the SPS resource allocation message.

As described above, after the UE 2702 checks that SPS resource allocation is actually performed, the UE 2702 may request (subsequent) SPS resource allocation again.

To this end, in step S2740, the UE 2702 may compare the timing when the first SPS UL grant was received (timing when the SPS resource allocation message was received in step S2730) with the generation timing of the message (timing when the uplink message was generated in step S2720).

In other words, the UE 2702 may calculate an offset value between the two timings by comparing the two timings.

Thereafter, in step S2750, the UE 2702 may request a change of the configuration for the transmission timing of a (subsequent) SPS UL grant from the eNB. In this case, the UE 2702 may transmit an SPS resource allocation request message including SPS resource allocation offset information to the eNB 2704.

For example, if the UE 2702 that has received the SPS resource allocation confirms that a latency requirement is not satisfied due to a difference between the generation timing of the message and the SPS resource allocation timing, the UE 2702 may transmit a message requesting that the SPS resource allocation timing is advanced (e.g., an offset value included in the request message is a negative value) to the eNB 2704.

In contrast, for another example, if the UE 2702 determines that the latency requirement is sufficiently satisfied by comparing the generation timing of the message with the SPS resource allocation timing, the UE 2702 may transmit a message for information indicating that the SPS resource allocation timing may be delayed (e.g., an offset value included in the message is a positive value) to the eNB 2704.

In other words, the UE 2702 may report a message, including information for adjusting an SPS offset (or information indicating the value of an offset to be changed), to the eNB 2704. In this case, the information included in the message may indicate (or represent) a specific value or may indicate an upper value and/or a lower bound within a given (or specific) range.

In this case, each value (specific value, upper value or lower bound) may have 0 (zero), a positive value or a negative value. Each absolute value may not be greater than the period value of a configured SPS.

For example, if the period of SPS is 100 ms and a transmission time interval (TTI) is 1 ms, the range of a specific offset value or the upper value or lower bound of an offset may be determined to be any one of values between −99 and +99.

Furthermore, in various embodiments of the present invention, if the generation period of a message is not matched with (or different from) the period of SPS resource allocation, the UE 2702 may request the eNB 2704 to match the period of the SPS resource allocation with the generation period of the message using a method of reporting an offset value. In this case, the UE 2702 may calculate an offset by comparing the generation timing of the message with the timing of the SPS resource allocation and then transmit information about the calculated offset value to the eNB 2704.

SPS Resource Allocation Information Sharing Between Multi-Cell

If a serving cell for a specific UE and neighboring cells form a single cell cluster, the cells belonging to the cluster may share information about a change (or variation) with other cells within the cluster whenever the change for SPS resource allocation occurs.

In this case, the change of the SPS resource allocation may mean a case where an SPS configuration is generated (or updated) as a new message (e.g., message for transmitting uplink data) for a specific UE is generated.

In this case, if a new SPS resource is necessary due to the generated (or updated) SPS configuration, a change of SPS resource allocation may occur.

In this case, the serving cell to which the specific UE belongs may allocate an SPS resource to the specific UE by taking into consideration resource allocation information of the neighbor cells (so that a collision of resource allocation is minimized).

Furthermore, a change of SPS resource allocation may mean a case where a UE belonging to a specific cell performs handover to another neighbor cell or a case where the existing SPS resource is released because a new UE is introduced from a neighbor cell. Furthermore, a change of SPS resource allocation may mean a case where a specific cell receives a resource scheduled in a neighbor cell and schedules it for a UE.

For example, if a specific UE deviates from the existing serving cell (first cell) and performs handover to a neighbor cell (second cell), the existing serving cell (first cell) may share with neighbor cells that an SPS resource (first SPS resource) occupied by the specific UE has been released.

In this case, the neighbor cell (second cell) that has accommodated the specific UE may notify (or share) cells, belonging to a cluster associated with the corresponding cell (or including the neighbor cell), that an SPS resource has been newly (or takes over SPS resource (first SPS resource) from the first cell, that is, the existing serving cell) allocated because a new UE has been introduced.

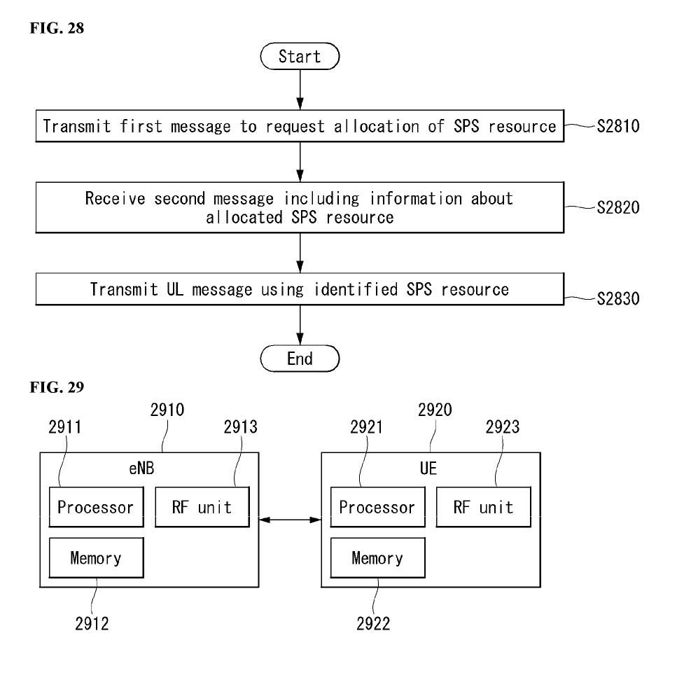

FIG. 28 shows an operational flowchart of a UE that requests SPS resource allocation according to various embodiments of the present invention. FIG. 28 is for convenience of description only, and does not limit the scope of the present invention.

Referring to FIG. 28, it is assumed that each of a UE and an eNB supports an SPS operation and the UE is located within a cell supported by the eNB.

In step S2810, the UE may transmit a first message to request the allocation of an SPS resource for transmitting a specific uplink message to the eNB. More specifically, before the UE receives an UL grant related to SPS from the eNB, it may request the eNB to allocate an SPS resource for semi-persistently transmitting a specific uplink message through the first message. In other words, if SPS has been configured with the eNB, the UE may transmit the first message to the eNB before an UL grant related to the configured SPS is initialized.

In this case, the first message may include first information indicating the timing or period in which the specific uplink message is generated and/or information indicating the timing when the specific uplink message is transmitted.

In this case, the specific uplink message may include a message related to safety in a V2X system.

Furthermore, if the first information is included in the first message, a UE operation in step S2810 may be similar to the UE operation in step S2630 of FIG. 26. In this case, the timing when the specific uplink message is transmitted may mean information about the timing (or resource) that the UE wants to transmit UL data to the eNB.

After the UE transmits the first message to the eNB, the UE may receive a second message including information about an SPS resource allocated in response to an allocation request of the SPS resource in step S2820.

In this case, the information about the allocated SPS resource may mean SPS resource allocation information modified in the eNB based on information included in the first message.

The UE operation in step S2820 may be similar to the UE operation in step S2550 of FIG. 25 and/or the UE operation in step S2650 of FIG. 26.

After the UE receives the second message, the UE may transmit a specific uplink message to the eNB using an SPS resource identified using the received information in step S2830.

In various embodiments of the present invention, the transmitting the first message to the eNB in step S2810 may be substituted with transmitting an SR to request the allocation of an SPS resource to the eNB.

In this case, if the aforementioned SPS has been configured, the UE may perform the operation described in the method part of allocating an SPS resource using an SR.

In this case, in step S2820, the UE may receive the second message further including offset information related to contiguous (or subsequent) SPS resource allocation.

Furthermore, in various embodiments of the present invention, a UE may drive a timer set to monitor a message for SPS resource allocation before it transmits the first message. In other words, the UE may confirm whether the message for allocating the SPS resource for the specific uplink message is received from the eNB within a given (or specific) time.

In this case, the timer may mean a timer in which the aforementioned delay margin has been taken into consideration.

Accordingly, after the timer expires, the UE may enter step S2810 and transmit the first message to the eNB.

Furthermore, in various embodiments of the present invention, the eNB may change the period of subsequent SPS resource allocation based on the allocation request of the SPS resource transmitted by the UE in step S2810. Accordingly, the UE may further receive a third message, including information about another SPS resource transmitted by the eNB in the changed period, from the eNB.

General Apparatus to which the Present Invention May be Applied

FIG. 29 illustrates a block diagram of a wireless communication apparatus according to an embodiment of the present invention.

Referring to FIG. 29, a wireless communication system includes a network node 2910 and multiple UEs 2920.

The network node 2910 includes a processor 2911, a memory 2912 and a communication module 2913. The processor 2911 implements the functions, processes and/or methods proposed in FIGS. 1 to 28. The layers of a wired/wireless interface protocol may be implemented by the processor 2911. The memory 2912 is connected to the processor 2911 and stores various pieces of information for driving the processor 2911. The communication module 2913 is connected to the processor 2911 and transmits and/or receives wired/wireless signals. In particular, if the network node 2910 is an eNB, the communication module 2913 may include a radio frequency (RF) unit for transmitting/receiving radio signals.

The UE 2920 includes a processor 2921, a memory 2922 and a communication module (or RF unit) 2923. The processor 2921 implements the functions, processes and/or methods proposed in FIGS. 1 to 28. The layers of a radio interface protocol may be implemented by the processor 2921. The memory 2922 is connected to the processor 2921 and stores various pieces of information for driving the processor 2921. The communication module 2923 is connected to the processor 2921 and transmits and/or receives radio signals.

The memory 2912, 2922 may be located inside or outside the processor 2911, 2921 and may be connected to the processor 2911, 2921 by various well-known means. Furthermore, the network node 2910 (if it is an eNB) and/or the UE 2920 may have a single antenna or multiple antennas.

In the aforementioned embodiments, the elements and characteristics of the present invention have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. The sequence of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present invention may be implemented by various means, for example, hardware, firmware, software or a combination of them. In the case of an implementation by hardware, the embodiment of the present invention may be implemented using one or more application-specific integrated circuits (ASICs), digital signal

1. A method of being allocated with a radio resource in a wireless communication system, the method performed by a user equipment comprising:
transmitting a first message for requesting an allocation of an semi-persistent signaling (SPS) resource for semi-persistently transmitting a specific uplink message to a base station, before an uplink grant related to SPS is received from the base station,
receiving a second message comprising information for the SPS resource allocated in response to the allocation request of the SPS resource, and
transmitting the specific uplink message to the base station using an SPS resource identified using the received information,
wherein the first message comprises at least one of first information indicating a timing or period in which the specific uplink message is generated and second information indicating a timing when the specific uplink message is transmitted.

2. The method of claim 1, wherein the specific uplink message comprises a message related to safety in a vehicle to everything (V2X) system.

3. The method of claim 1, wherein the transmitting the first message comprises transmitting a scheduling request to request the allocation of the SPS resource.

4. The method of claim 3, wherein the information about the allocated SPS resource included in the second message further comprises offset information related to subsequent SPS resource allocation.

5. The method of claim 1, wherein if the first information is included in the first message, the second message is periodically received from the base station at a timing determined according to Equation 8 below.
(10*SFN+subframe)=[(10*SFNrequest+subframerequest)+N*semiPersistSchedIntervalUL] modulo 10240 <Equation 8>
wherein the SFN means a system frame number, the subframe means a number of a subframe, the SFNrequest means a system frame number for requesting the allocation of the SPS resource, the subframerequest means a number of a subframe to request the allocation of the SPS resource, and the semiPersistentSchedIntervalUL means an interval of uplink SPS.

6. The method of claim 1, wherein the second information comprises at least one of an upper value of a specific timing or an allocation timing of the SPS resource and a lower bound of an allocation timing of the SPS resource.

7. The method of claim 6, wherein each of the upper value and the lower bound is expressed as at least one of a system frame number and a subframe number.

8. The method of claim 1, wherein the transmitting the first message to request the allocation of the SPS resource for semi-persistently transmitting the specific uplink message to a base station comprises:
driving a timer set to monitor a message for the allocation of the SPS resource, and
transmitting the first message to the base station when the timer expires.

9. The method of claim 1, further comprising receiving a third message comprising information about another SPS resource transmitted in at least one of a period and offset changed based on the allocation request of the SPS resource from the base station.

10. A user equipment allocated with a radio resource in a wireless communication system, the user equipment comprising:
a transceiver for transmitting and receiving radio signals, and
a processor functionally coupled to the transceiver,
wherein the processor controls to:
transmit a first message for requesting an allocation of an semi-persistent signaling (SPS) resource for semi-persistently transmitting a specific uplink message to a base station before an uplink grant related to SPS is received from the base station,
receive a second message comprising information for the SPS resource allocated in response to the allocation request of the SPS resource, and
transmit the specific uplink message to the base station using an SPS resource identified using the received information, and
the first message comprises at least one of first information indicating a timing or period in which the specific uplink message is generated and second information indicating a timing when the specific uplink message is transmitted.
